(19) United States
(12) Patent Application Publication
(10) Pub. No.: US 2007/0187119 A1
(43) Pub. Date: Aug. 16, 2007

(54) Device for resurfacing an ice rink or track

(76) Inventor: Christopher John Fawcett, Calgary (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(21) Appl. No.: 10/596,841

(22) PCT Filed: Dec. 29, 2004
(86) PCT No.: PCT/GB04/05404

§ 371 Date: Jun. 27, 2006

(30) Foreign Application Priority Data
Dec. 29, 2003 (GB) 0330103.3

(51) Int. Cl. A01B 33/00

(52) U.S. Cl. 172/35

(57) ABSTRACT

A device for resurfacing an ice rink or track. The device includes a drive system (13) for moving the device over the surface of the ice rink or track, at least one heater device (9) including a heat source (39) and a conductive member (38) for transferring heat from the heat source to the surface of the ice. A heater device (9), a wheel (71) and winch system (107) for the ice rink resurfacing device are also described.

This invention relates to a device for resurfacing an ice rink or track, a heater device, a wheel and a winch system for the resurfacing device.

Most ice rinks, curling rinks and tracks are resurfaced by an ice scraping machine first invented by Zamboni around 70 years ago. The Zamboni type machine comprises a vehicle with a scraper arranged to scrape a thin surface layer off the ice from a surface, store the resultant snow in a bin and release water from an onboard tank onto the rink, behind the direction of travel. This floods the area behind the vehicle which then refreezes as a smooth surface. Hot water is sometimes used to achieve a better binding with the underlying ice. This is an example of an open system since new water has to be added to resurface the rink.

In practice, several runs of the scraping machines are required to give a good surface if the starting surface is poor. The scraping machine is arranged to resurface the rink which can cause the surface to refreeze at slightly different levels thereby generating a surface which is not perfectly flat and which undulates. With such surfaces, water runs out of grooves in the ice and does not completely fill them thus resulting in a partially repaired surface.

The arrangement of a typical scraping machine is such that it is unable to resurface the edges of the rink thereby requiring edging from time to time with another machine to cut back any ice build up. In addition, the ice scraping machines require a skilled operator to produce a reasonable surface finish who must drive the machine throughout the resurfacing process. They also require considerable servicing to maintain blade sharpness, for emptying and filling the snow bin and water tank, and refuelling with potentially explosive gas. Considerable space is required to house the vehicle and allow access to the rink. Scraping machines are also noisy and polluting unless electric powered, which is generally uneconomic because of the high cost and short service life of the large electric cells required. Providing electricity by cable from an overhead source is complicated and expensive.

Furthermore, the scraping machines are arranged such that they cannot discriminate between resurfacing actions required to clean the ice, i.e. remove the upper layer of ice because it is contaminated with dirt, and actions to resurface to obtain a smoother surface finish since in every operation the upper layer of ice is scraped away. In practice, the upper surface of an ice rink does not become contaminated with dirt over short periods of time and therefore it is necessary to more frequently resurface to obtain an improved surface finish than it is to clean the ice. Thus, there is a need for a device that can better control resurfacing to optimise resurfacing operations.

U.S. Pat. No. 4,586,275 describes a device for resurfacing a curling rink. The device includes an ice melting machine arranged to melt the surface ice and a winch arrangement for drawing the melting machine across the ice. This is an example of a closed system since the existing water is reused to form the new surface. The ice melting machine described includes a plurality of burners fuelled by propane or similar liquefied petroleum gas. The main problem with a melting machine of this type is that it is very difficult to control the melting process since burners produce highly localised and directional heating thereby causing significant temperature gradients between burners. This leads to uneven melting of the surface ice and produces a coarse surface finish. Furthermore, the device is fuelled by highly flammable materials which makes it inherently unsafe. The fuel is carried by the machine and thus any fuel leakage would be potentially explosive. Any dirt located on the rink being resurfaced, for example litter left on a public ice rink, would burn as the ice melting machine passed over it. The combusted remains would contaminate the melt water and be frozen into the ice, producing a poor surface finish. Alternatively, it would be necessary to clean the ice prior to operating the resurfacing device which is time consuming.

There are other known burner type devices that suffer from the same drawbacks as the device described in U.S. Pat. No. 4,586,275.

Accordingly the present invention seeks to mitigate some of the aforementioned problems.

According to one aspect of the present invention there is provided a device for resurfacing an ice rink or track including a drive system for moving the device over the surface of the ice rink or track, at least one heater device including a heat source and a conductive member for transferring heat from the heat source to the surface of the ice.

Advantageously the device includes a computer controller. Preferably, the computer controller is arranged to control the depth to which the ice is melted, operation of the drive system and the amount of heat supplied to the or each heater device. The computer controller can be arranged to periodically interrupt the supply of heat to the or each heater device. This enables the computer controller to cycle power to the or each heater device when there is a limited power supply.

Preferably the conductive member has a substantially planar surface for contacting the ice and includes means for reducing warping caused by differential heating of the body. Preferably the conductive member includes a body and the means for reducing warping caused by differential heating includes comprises a plurality of slots formed in the body. The means for reducing warping caused by differential heating may also including bracing members for increasing the rigidity of the conductive member.

Advantageously the or each heater device includes at least one thermostatic device for monitoring the temperature of the conductive member. Preferably the heater device includes a first thermostatic device for detecting when the conductive member has exceeded a first predetermined temperature and a second thermostatic device arranged to detect when the conductive member has fallen below a second predetermined temperature.

Advantageously the resurfacing device can include a plurality of heater devices. Preferably the device includes between 1 and 60 heater devices, and more preferably between 10 and 50 heater devices, and more preferably still between 20 and 40 heater devices.

Advantageously the vertical position of the or each heater device relative to the surface of the ice is adjustable. The word “vertical” assumes that the ice rink or track will be laid substantially horizontally. If the rink or track is inclined then “vertical” should be construed to mean substantially perpendicular to the rink or track. Advantageously the device includes lifting means for adjusting the position of the or each heater device relative to the surface of the ice. Preferably, operation of the lifting means is controlled by the computer controller. The computer controller is arranged such that it can adjust the vertical position of each heater device individually and may adjust the vertical positions of at least some of the heater devices substantially simultaneously.

The heat source is arranged to heat the conductive member, in use, to a temperature within the range 20 to 100 degrees Celsius. Preferably the heat source is arranged to heat the conductive member, in use, to a temperature within the range 30 to 90 degrees Celsius, and more preferably to a temperature within the range 40 to 80 degrees Celsius.

Advantageously the heat source may comprise at least one electrically heatable element. The or each electrically heatable element is located on the conductive member and transfers heat thereto. As the temperature of the electrically heatable element rises heat is transferred to the conductive member and is conducted through that member to the ice, when the conductive member is located on the ice. Preferably the or each electrically heatable element includes a nichrome ribbon coated in an electrical insulating material. Advantageously the conductive member comprises a metallic plate and the or each electrically heatable element can be arrange to extend across the upper surface of the, such that that the lower surface of the plate is heated approximately evenly across the plate. A thermal insulating layer may be located above the or each electrically heatable element to reduce heat loss away from the ice. Thus the or each heater device may comprise a stratified structure having a metallic plate for conducting heat to the ice, an arrangement of heating element(s) located on the upper surface of the metallic plate for heating the plate, said heating element(s) surrounded by an electrical insulating material, a thermal insulating layer and a further metallic plate for reducing the warping effects caused by differential heating. The stratified structure is held together by fixing means, such as an arrangement of bolts.

Alternatively the at least one heat source may comprise a liquid. Preferably the liquid is water which is supplied from a hot water source to the or each conductive member. For example, the hot water may be heated in a tank using any suitable means, such as solar power, electrical emersion heaters or gas heaters, and is piped to the or each heater device. Preferably the conductive member includes a network of channels for receiving the hot liquid to distribute heat across the conductive member. Heat is transferred from the liquid to the ice via the conductive member. The cooled liquid exits the conductive member and is directed to a cold liquid store. Preferably the liquid supplied to the conductive members is within the temperature range 70 to 90 degrees Celsius and exits in the range 10 to 40 degrees Celsius.

The or each heater device can be mounted on an elongate structure and the drive system is arranged to move the elongate structure across the surface of the ice. Preferably the elongate structure includes a fixed section and at least one moveable section for adjusting the effective length of the elongate structure. This is particularly advantageous since it allows the resurfacing device to treat ice rinks and tracks wherein the width of the track varies along its length, or vice versa. Preferably the elongate structure comprises a central fixed section and two moveable sections mounted thereon. Each moveable section is arranged to slide relative to the central section and is extensible towards peripheral portions of the ice rink/track and is retractable towards central portions of the ice rink/track. Movement of the moveable sections is controlled by the drive system. Preferably the drive system is controlled by the computer controller.

The resurfacing device includes at least one sensor for detecting the position of the or each moveable section. Advantageously the device includes a sensor for detecting when each heater device mounted on one of the moveable sections moves past the end of the fixed portion when extending. The sensor is connected to the computer controller. The computer controller is arranged to control the lifting means to adjust the vertical position of the or each heater device relative to the ice. Preferably each moveable section includes at least one sensor for detecting a barrier at the edge of the rink or track. The or each sensor is connected to the computer controller, which is arranged control the drive system to control extension and retraction of each moveable section.

The device also includes sensors for detecting when each moveable section is fully retracted.

Advantageously the resurfacing device may include means for determining the alignment of the or each moveable section relative to the fixed section. Preferably the means for determining the alignment of the or each moveable section relative to the fixed section includes a transducer arranged to detect the distance between the fixed section and each moveable section at a predetermined position. The transducer is connected to the computer controller, which is arranged to control operation of the drive system to realign the or each moveable section with the fixed section 5.

Preferably the resurfacing device includes a plurality of heater devices arranged to extend substantially across the width or length of the rink or track thereby forming a substantially continuous melting zone across the rink or track. This enables the entire rink to be resurfaced in a single pass. Preferably the heater devices are mounted on the elongate structure end to end thereby forming the substantially continuous melting zone.

Advantageously the resurfacing device may include means for adjusting the alignment of the resurfacing device as it moves across the ice. Preferably the means for adjusting the alignment of the resurfacing device includes a plurality of sensors for detecting an arrangement of markers located below the ice. The sensors are connected to the computer controller, which is arranged to control operation of the drive system. If the sensors detect that the resurfacing device is incorrectly aligned the computer controller controls the drive system to adjust the speed of one end of the device relative to the other end to realign the device.

The sensors for detecting the markers can be arranged to measure the depth of ice.

Alternatively, the means for adjusting the alignment of the resurfacing device may include an arrangement of lasers, sensors and reflectors for determining whether the device is correctly aligned. If the sensors detect that the resurfacing device is incorrectly aligned the computer controller controls the drive system to adjust the speed of one end of the device relative to the other end to realign the device.

Advantageously the drive system includes a plurality of wheel modules having a plurality of wheels, a motor arranged to drive the wheels and an encoder for supplying operational information to the computer controller. The wheels are preferably arranged to grip the ice when rotated about their axes of rotation and are arranged to slide over the ice when driven in a direction substantially parallel to their axes of rotation. The wheels include a plurality of grooves and teeth formed alternately in the curved surface of the wheel. Preferably each tooth has a channel formed in its upper surface, thereby forming two ridges extending along the length of the tooth.

Advantageously the resurfacing device may include at least one cell for supplying electrical power to at least one of the drive system, the computer controller, the lifting means and the sensors, and a cell charger connected to a mains supply for providing power to the cell.

Advantageously the resurfacing device may include a winch system for adjusting the vertical position of the resurfacing device relative to the rink or track. This enables the resurfacing device to be lifted from the rink or track and to be stored in the roof space of a building housing the rink or track. Preferably the winch system includes at least one flexible electrical connector attached to a mains supply for supplying electricity to at least one of the or each heater device and the cell charger, wherein the winch system is arranged to payout and retract the or each flexible electrical connector when the resurfacing device is lowered and raised respectively. Operation of the winch system is controlled by the computer controller.

The drive system may include at least one of a rack and pinion drive assembly and a screw drive assembly. Preferably the rack and pinion drive assembly extends the length of the rink or track and has a second substantially identical assembly located along the opposing side of the rink or track. The resurfacing device extends across the width of the rink or track and is connected towards each end to the rack and pinion drive assemblies. When the drive assemblies operate, the resurfacing device is conveyed over the ice. The computer controller controls operation of the drive assemblies and can thereby adjust the alignment of the resurfacing device. The screw drive assemblies are similarly arranged.

Advantageously the resurfacing device may be arranged to receive electrical power from electrical supply lines extending substantially along the length or width of the rink or track.

The resurfacing device may include water supply means for distributing water over the surface of the ice. The computer controller is arranged to control the amount of water supplied to the device and the amount applied to the surface of the ice. The or each heater device preferably includes a network of channels and water outlets for depositing water onto the surface of the ice. Preferably the means for adjusting the vertical position of the heater device is arranged to move the heater device to a position in which it impinges on a water supply line and thereby inhibits the supply of water to the heater device.

Advantageously the resurfacing device may include means for removing melt water from the surface of the ice. The resurfacing device may include filter means for cleaning water removed from the ice. Preferably the resurfacing device includes at least one resurfacing cleaner module including a support member having a leading edge and a trailing edge, a first heater device pivotally attached to the leading edge and a second heater device pivotally attached to the trailing edge, and a water inlet formed in the support member. The resurfacing device includes at least one vacuum means for drawing melt water through the water inlet and for directing the water to the filter means to clean the melt water. Preferably the support member includes water outlets arranged to receive clean water from the filter means for depositing on the surface of the ice.

According to second aspect of the invention there is provided a heater device for an ice rink resurfacing device including a heat source and a conductive member for transferring heat from the heat source to the surface of the ice.

The heat source may include an electric heating element comprising a nichrome ribbon coated in an electric insulating material. Alternatively the heat source may comprise a liquid. Preferably the heat source is arranged to heat the conductive member, in use, to a temperature within the range 20 to 100 degrees Celsius. Preferably the heat source is arranged to heat the conductive member, in use, to a temperature within the range 30 to 90 degrees Celsius, and more preferably to a temperature within the range 40 to 80 degrees Celsius.

Advantageously the heater device may include at least one of means for reducing warping caused by differential heating of the body and water supply channels and outlets arranged for dispersing water on to the surface of the ice.

According to a third aspect of the invention there is provided a wheel for an ice resurfacing device drive system arranged rotation about an axis and to grip the ice when driven about its axis and to slide over the ice when driven in a direction substantially parallel to the axis of rotation. Advantageously the wheel may include a plurality of grooves and teeth formed alternately in the curved surface of the wheel. Preferably each tooth is profiled to include at least one ridge in its outer surface. Preferably each tooth has a channel formed in its upper surface, thereby forming two ridges extending along the length of the tooth.

According to a fourth aspect of the invention there is provided a winch system for raising and lowering an ice resurfacing device including at least one flexible connector for supporting the weight of the resurfacing device, first and second fixed pulley wheels, a moveable pulley wheel, and a drive system for moving the moveable pulley wheel, wherein the flexible connector is anchored at one end to a support and is wrapped around the pulley wheels, and the position of the ice resurfacing device is controlled by the drive system adjusting the position of the moveable pulley wheel.

Preferably the winch system includes at least one of a plurality of flexible connector elements for supporting the weight of the resurfacing device, and may include at least one electrical supply cable for supplying electrical power to the resurfacing device from a power source. The winch system may include at least one control cable for carrying electrical signals from a computer controller located on the ice resurfacing device to the drive system and/or at least one sensor for determining the position of the ice resurfacing device. Preferably the sensor determines the position of the moveable pulley wheel and the computer controller determines the position of the ice resurfacing device. In one embodiment, the moveable pulley wheel is located in a trough and is arranged for sliding movement therein. The sensor determines the position of the moveable pulley wheel within the trough. Alternatively, the flexible connector element, the electrical supply cable and/or the control cable can be marked and the sensor can determine the amount of cable payout. Alternatively one of the pulley wheels can be marked, or have a hole formed therein, and the sensor can detect the number of revolutions of the pulley wheel and the computer controller can determine the position of the ice resurfacing device.

An embodiment of the invention will now be described, by way of example only, with reference to the accompanying drawings in which like references indicate equivalent features, wherein:

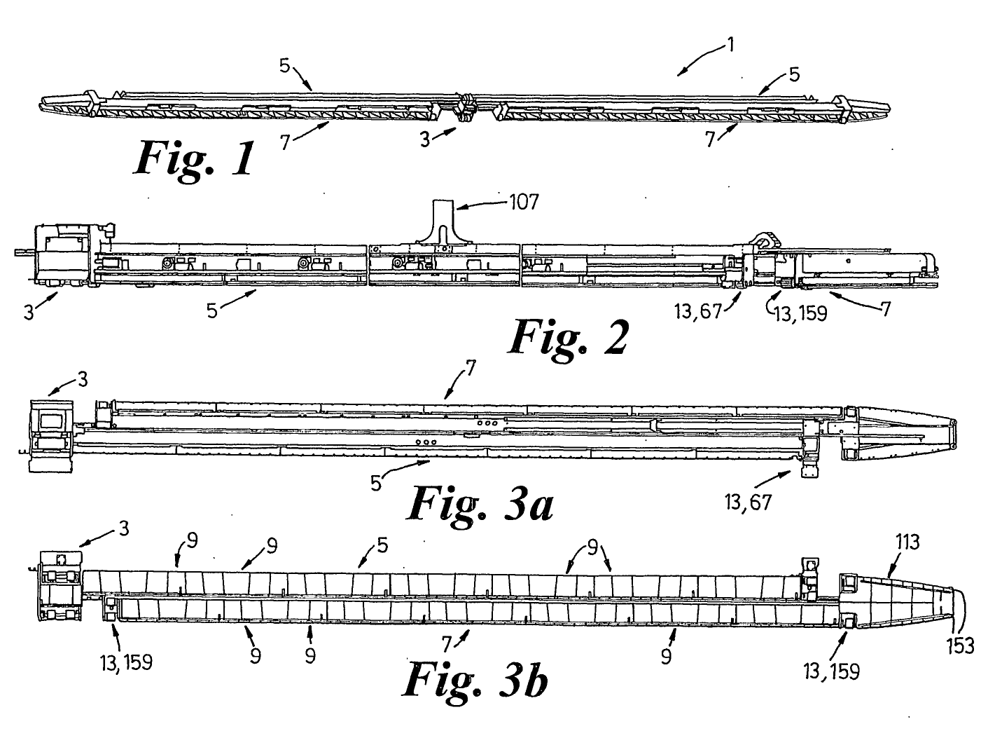

FIG. 1 is a perspective view of a first embodiment of the invention from above and behind;

FIG. 2 is a front view of part of the embodiment of FIG. 1;

FIG. 3a is a plan view from above of part of the embodiment of FIG. 1;

FIG. 3b is a plan view from below of part of the embodiment of FIG. 1;

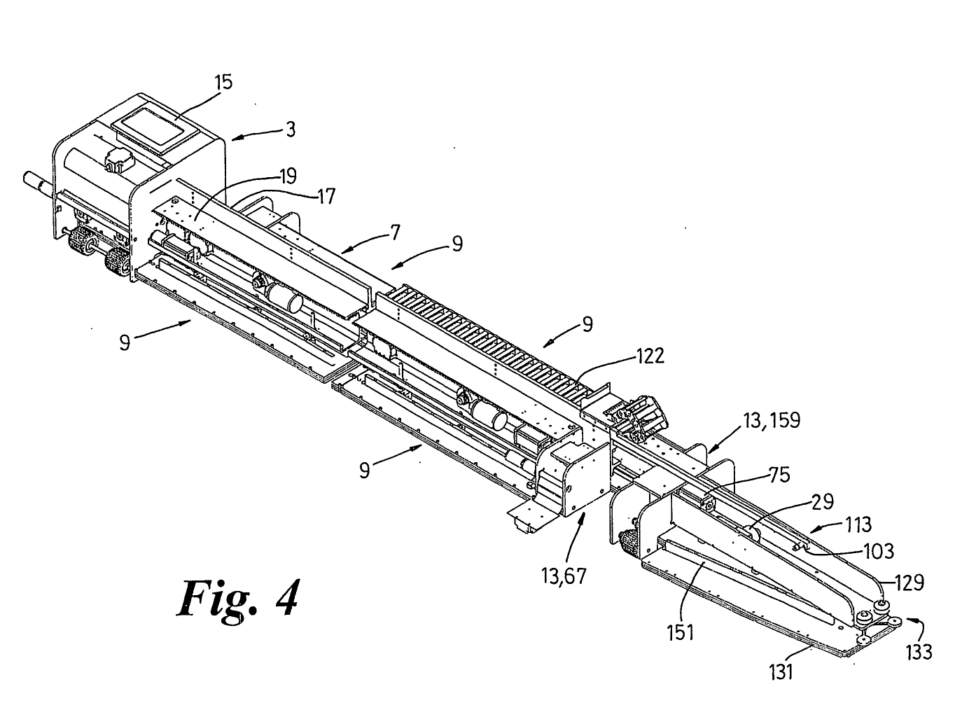

FIG. 4 is a perspective view of part of the embodiment of FIG. 1 with five heater modules omitted for clarity;

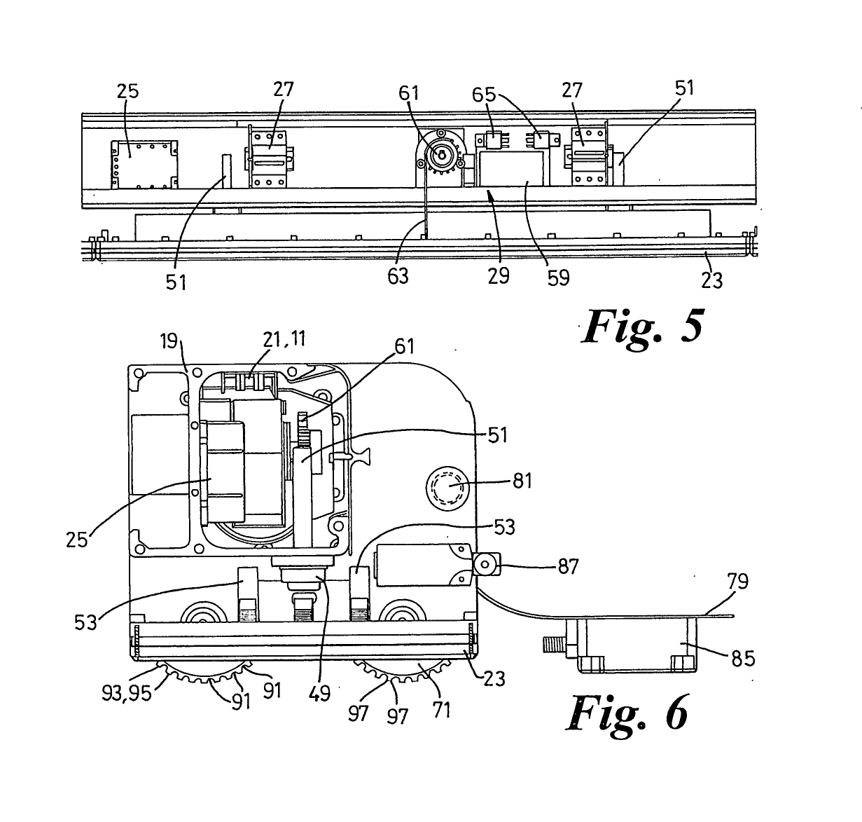

FIG. 5 is a front view of a heater module mounted on a boom;

FIG. 6 is sectional view of a fixed boom section with a heater module mounted thereon;

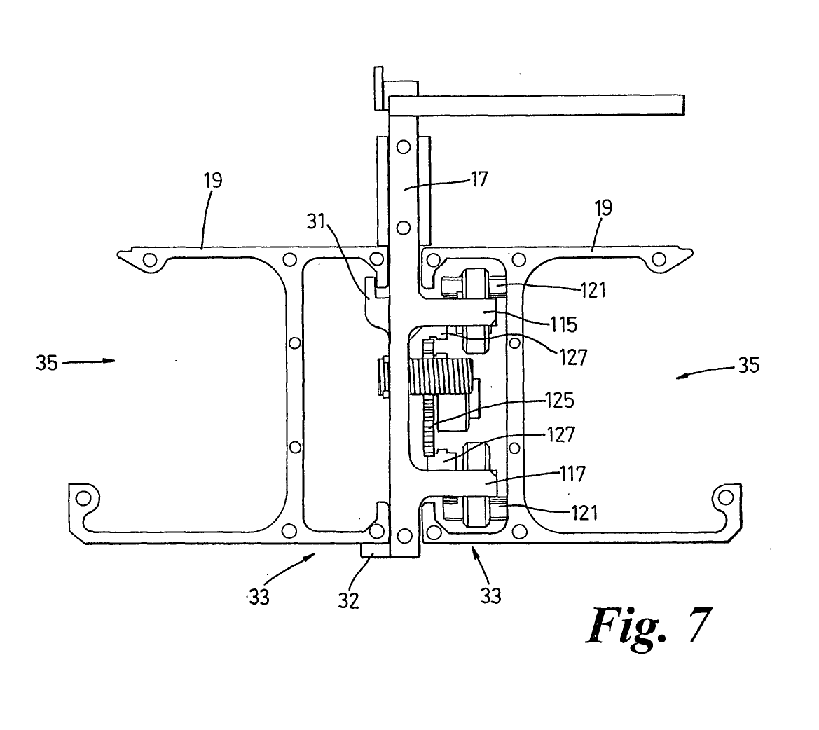

FIG. 7 is a sectional view showing a retractable boom section mounted on a fixed boom section;

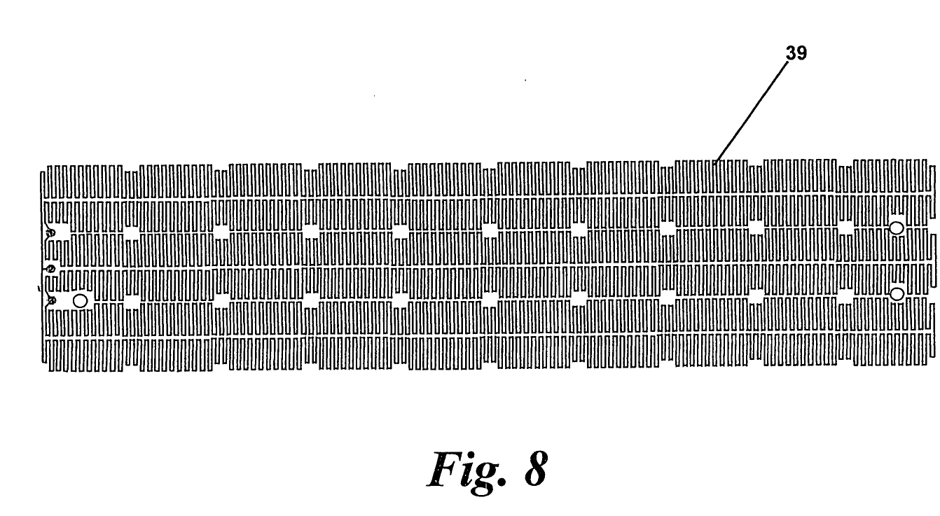

FIG. 8 is a plan view of an etched foil heater for a heatable plate;

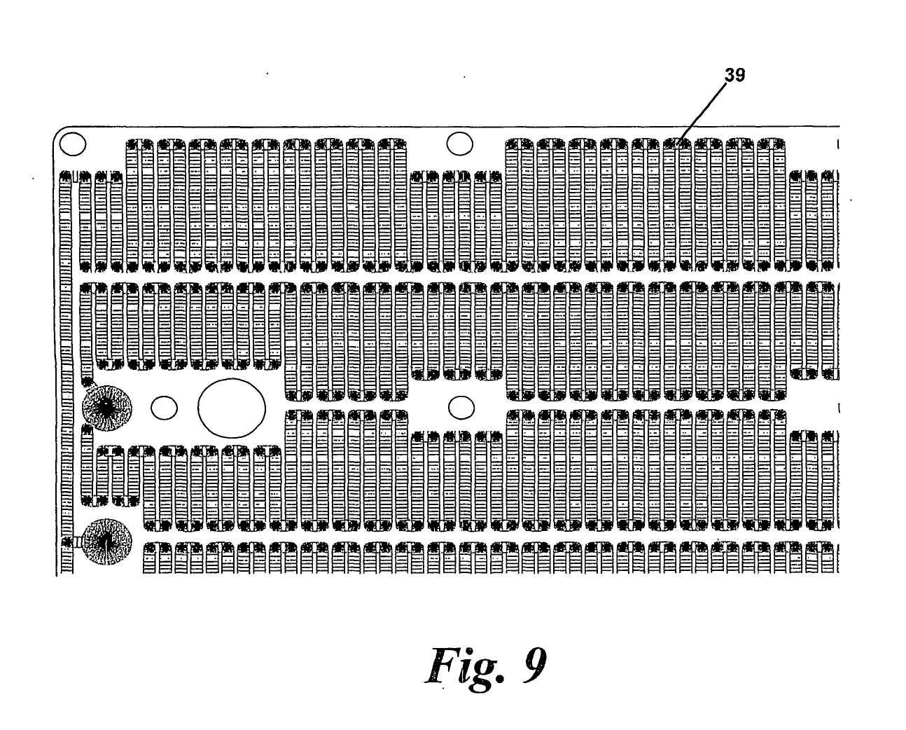

FIG. 9 is a plan view of part of the etched foil heater of FIG. 8 in larger scale;

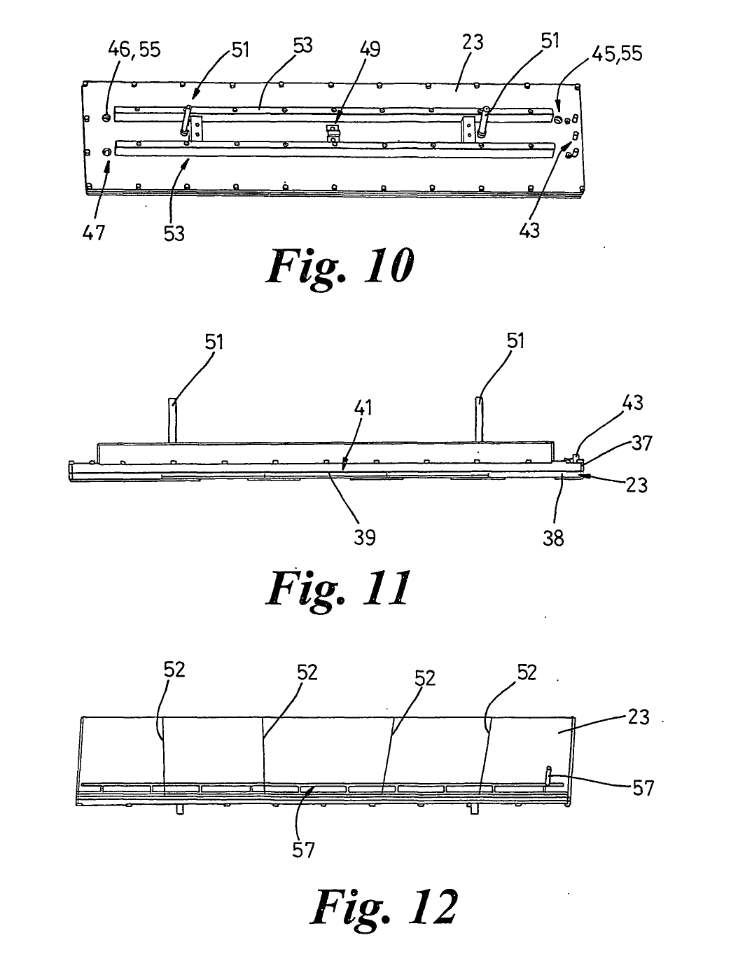

FIG. 10 is a view from above of a heatable plate;

FIG. 11 is a side view of the heatable plate;

FIG. 12 is a view from below of the heatable plate;

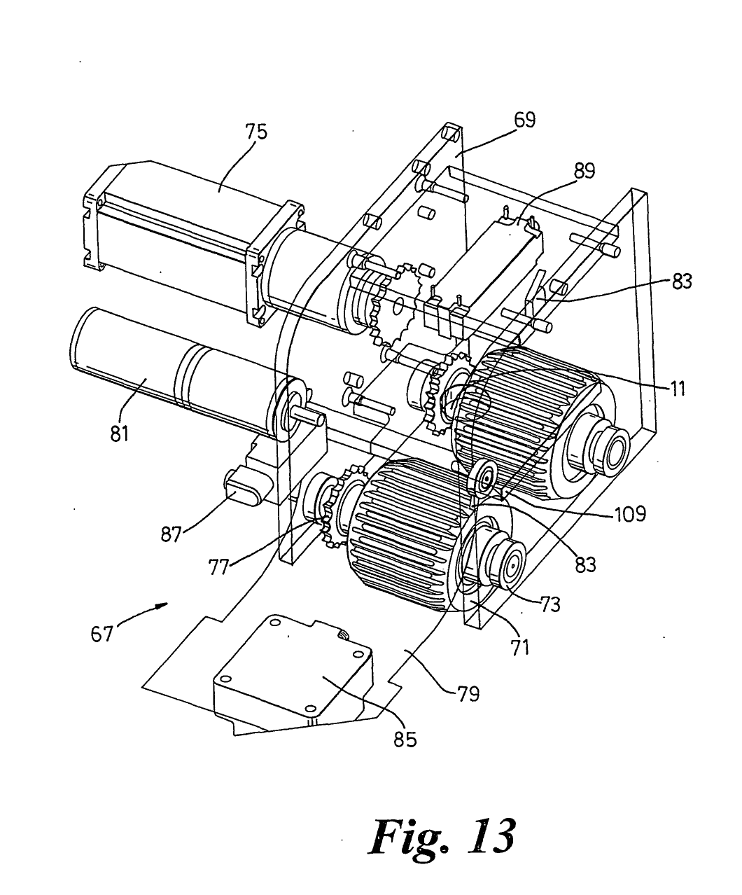

FIG. 13 is a perspective view from above of a wheel module for the fixed boom section;

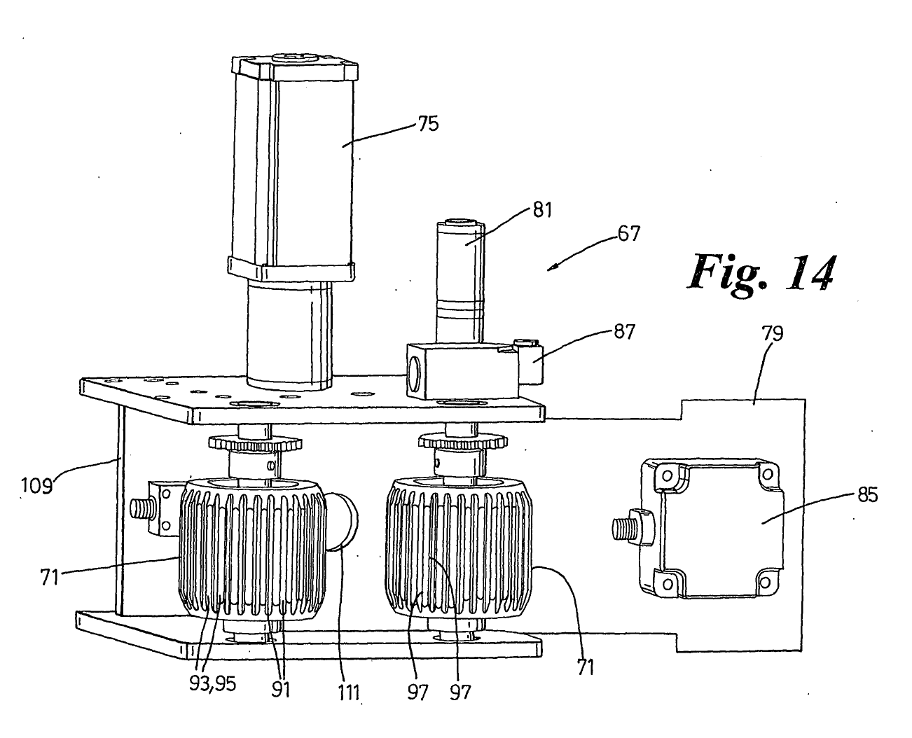

FIG. 14 is a perspective view from below of the wheel module for the fixed boom section;

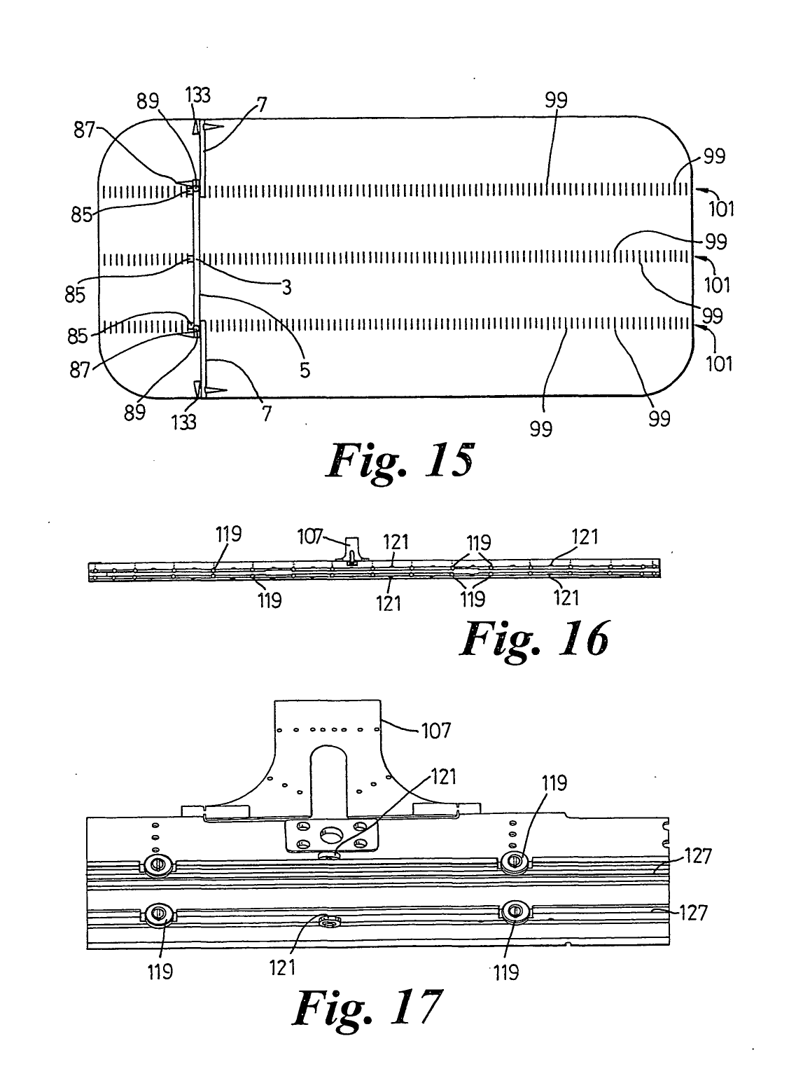

FIG. 15 is a schematic of an ice rink with a resurfacing device located thereon with foil strip markers located below the ice;

FIG. 16 is a rear view of the fixed boom section, without a retractable boom section mounted thereon.

FIG. 17 shows the fixed boom section of FIG. 16 in larger scale;

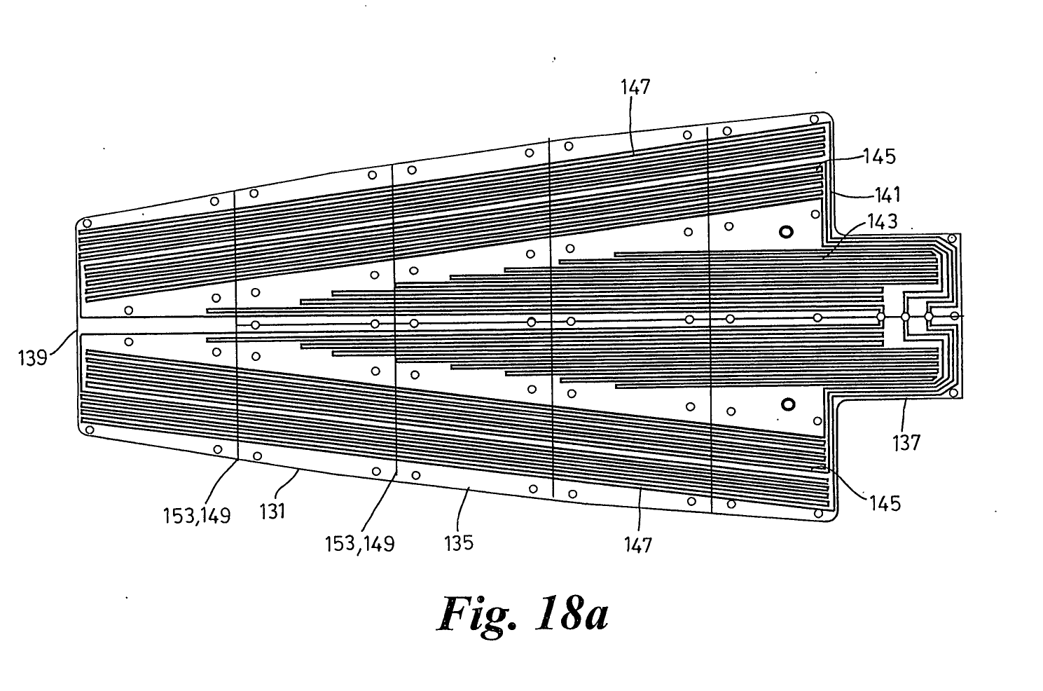

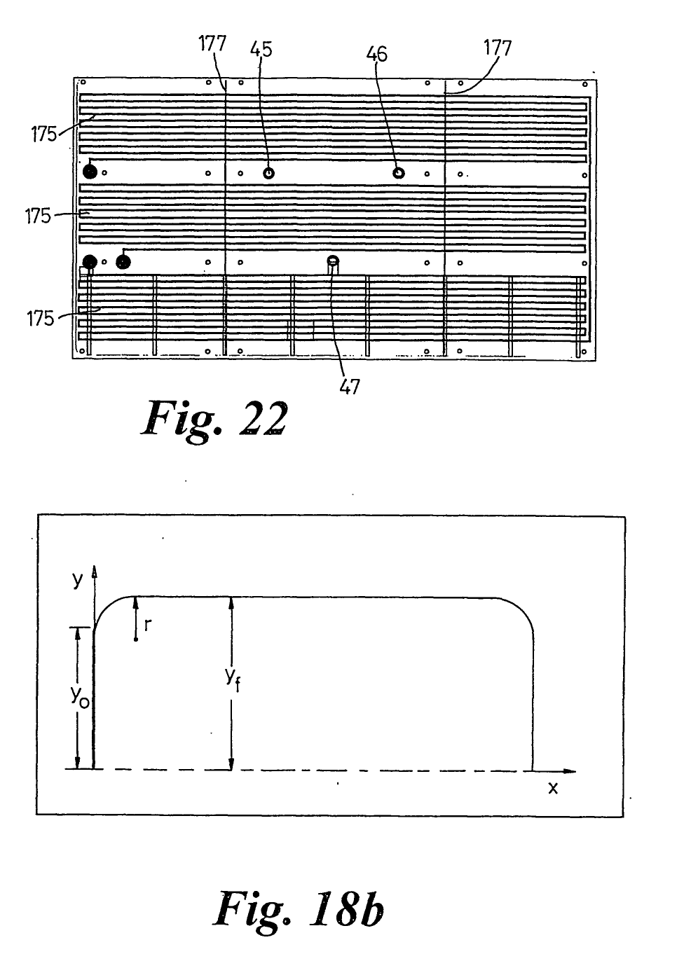

FIG. 18a is a plan view of an etched foil heater for a heatable end plate;

FIG. 18b is the geometry of a corner of a rink;

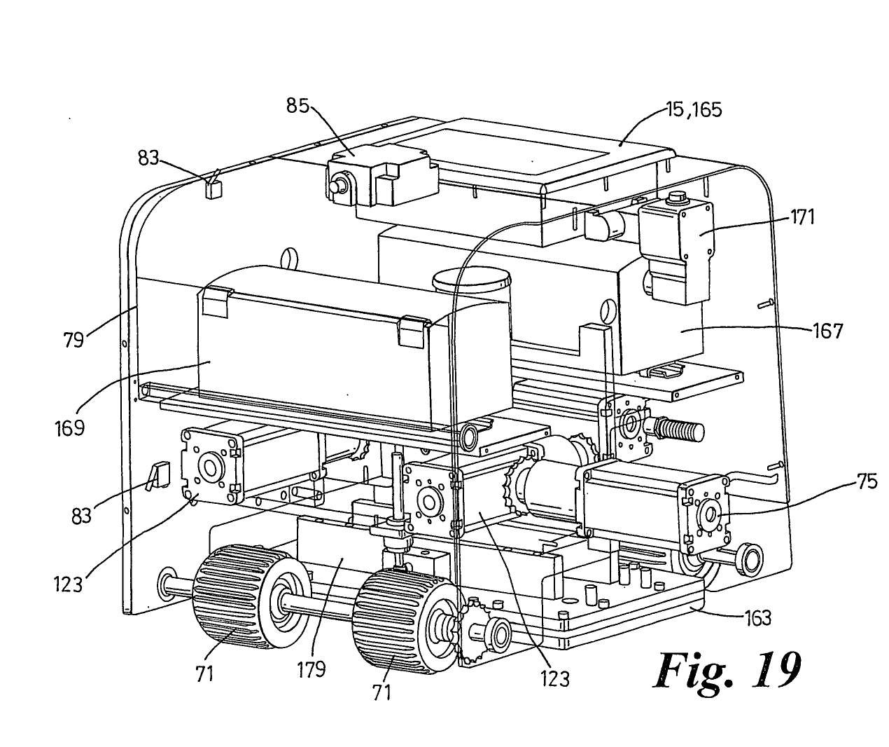

FIG. 19 is a perspective view of a centre boom section;

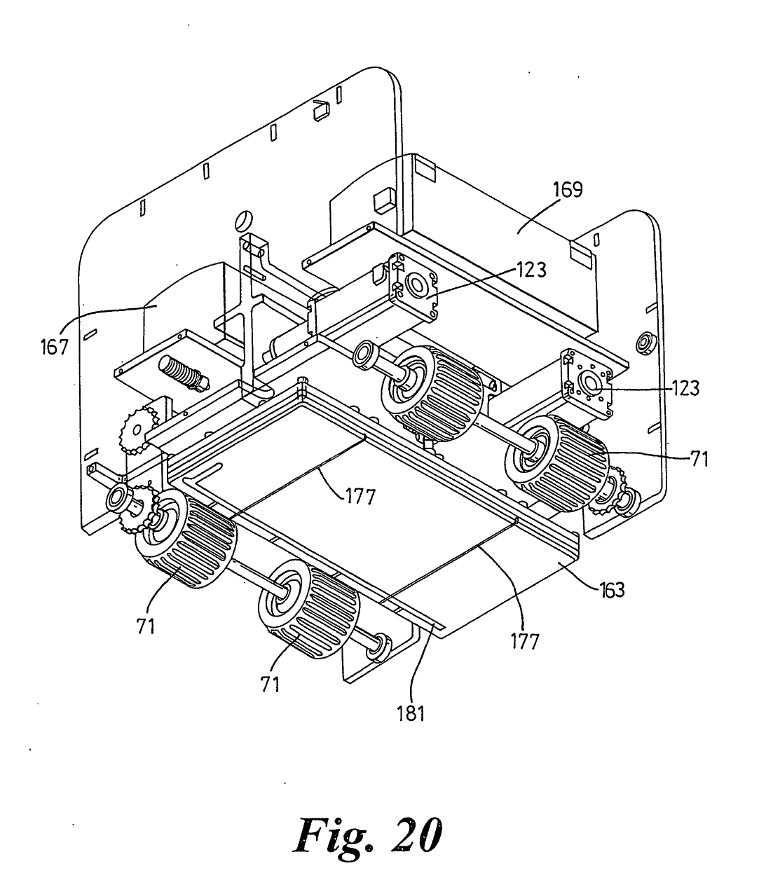

FIG. 20 is a perspective view of the centre boom section from below;

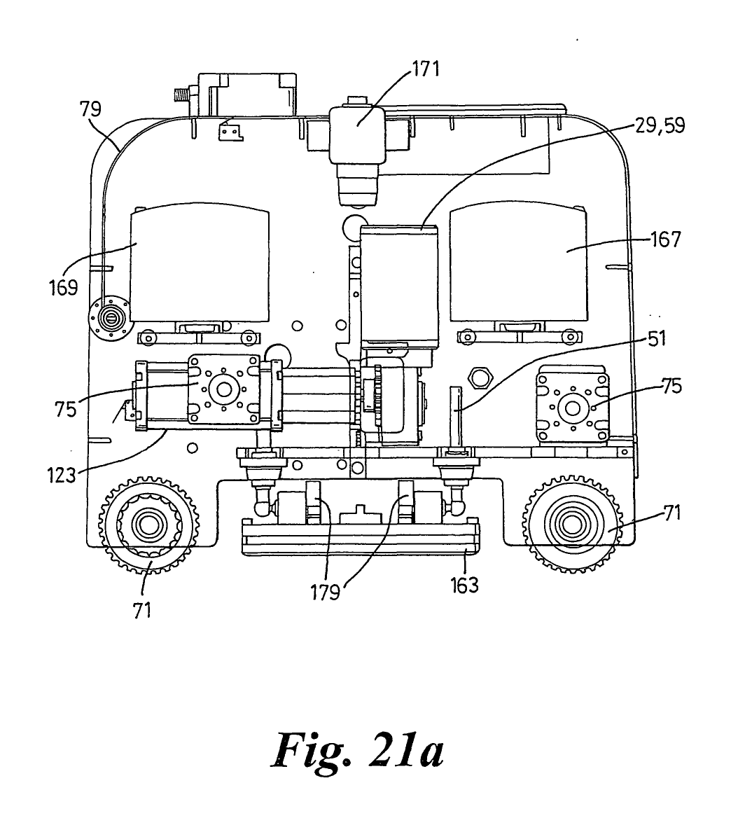

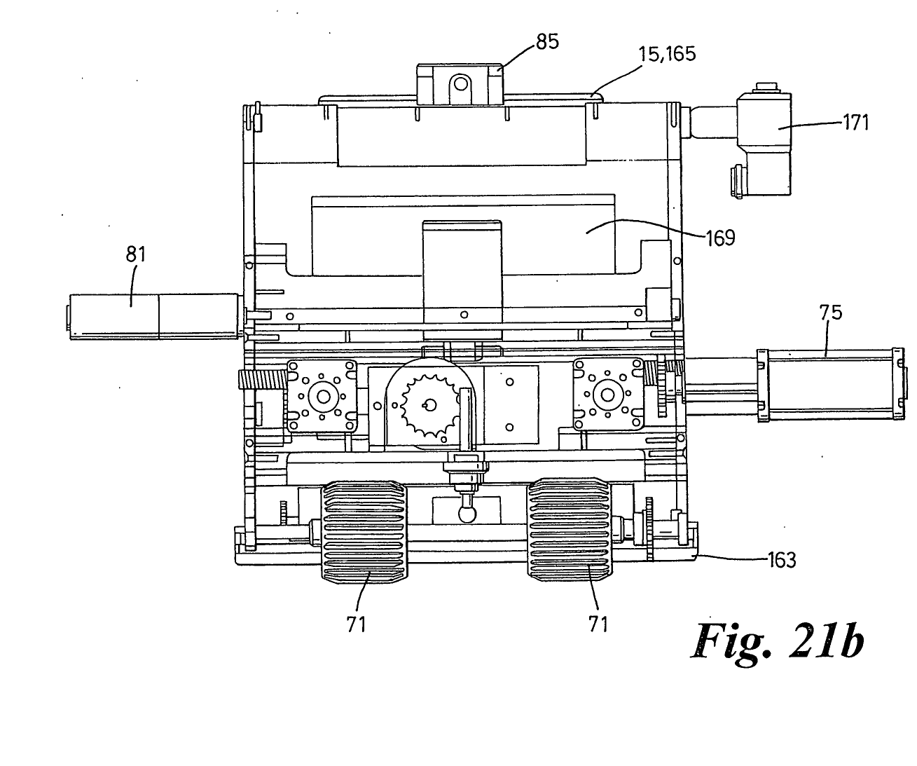

FIG. 21a is a side view of the centre boom section;

FIG. 21b is a front view of the centre boom section;

FIG. 22 is a plan view of an etched foil heater for a heatable centre plate;

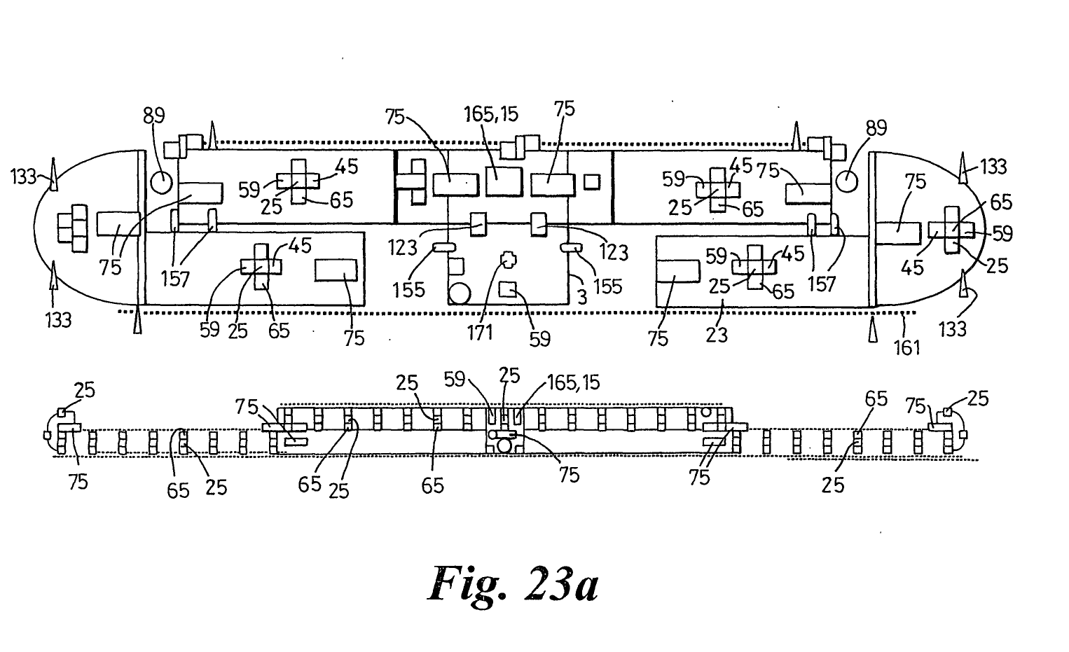

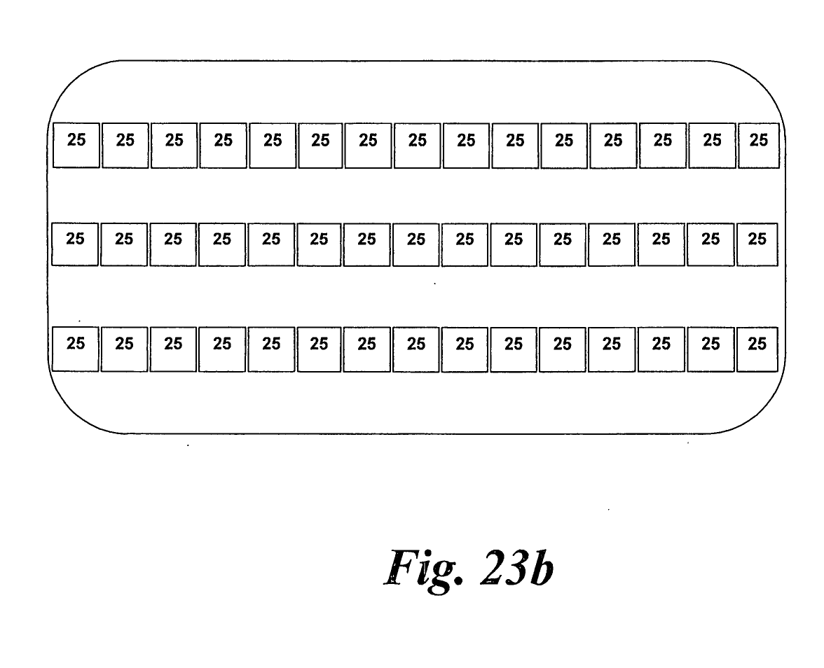

FIG. 23a is a schematic of the devices mounted on the resurfacing device that interface with a Programmable Logic Controller (PLC);

FIG. 23b is a schematic representing ice depth measurements.

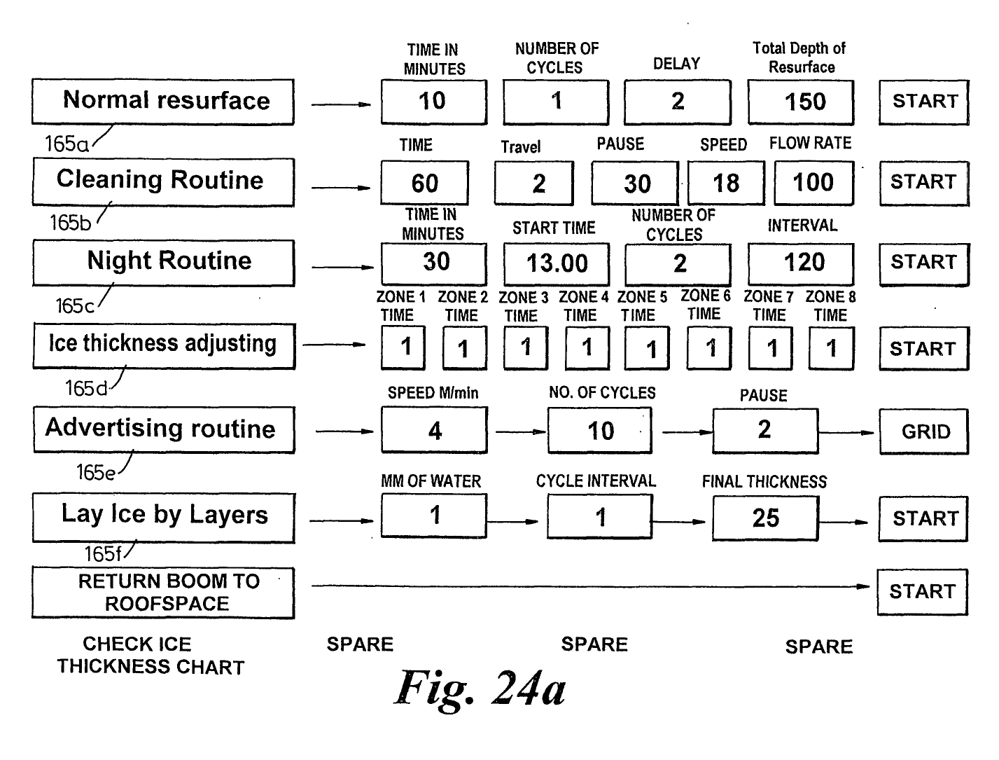

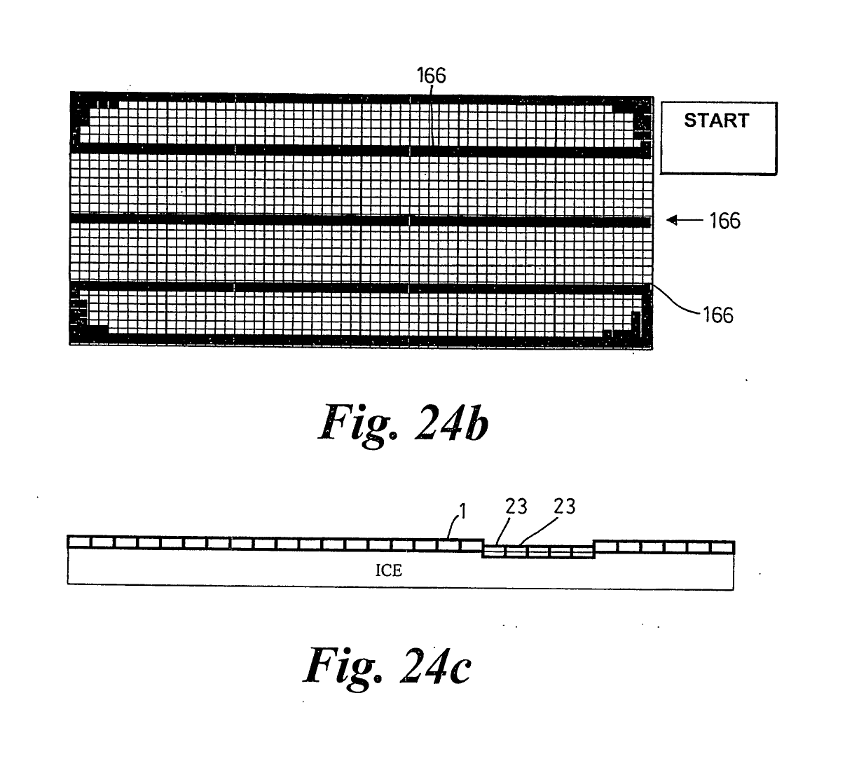

FIG. 24a is a diagrammatic view of a display screen for a Human Machine Interface (HMI) that is connected to the PLC and a grid of advertising zones for an ice rink;

FIG. 24b is a diagrammatic view of an ice rink split in to zones for advertisements;

FIG. 24c is a diagrammatic view of the resurfacing device melting ice in a localised area for the purposes of laying advertising under the ice.

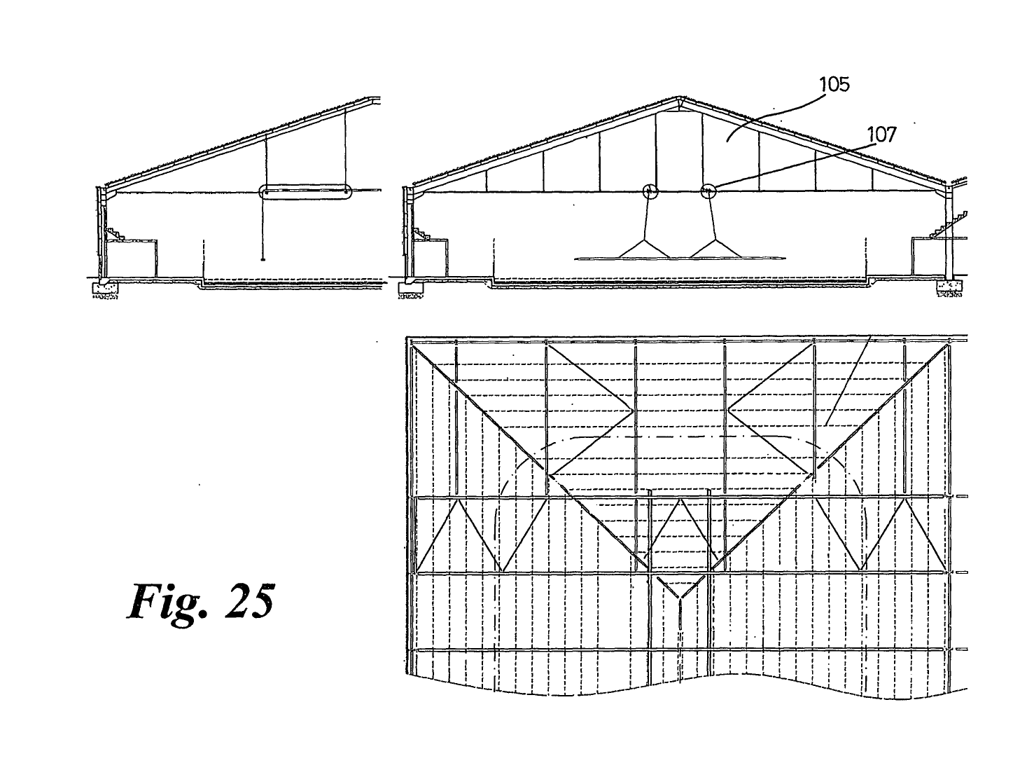

FIG. 25 shows the resurfacing device being lowered from the roof space of a building housing the ice rink;

FIG. 26 is a perspective view of a power supply and lifting system;

FIG. 27 is a side view of a winch assembly that carries a lifting rope and power cables;

FIG. 28 is a perspective view of a pulley wheel mounted in a frame that is used in the winch assembly;

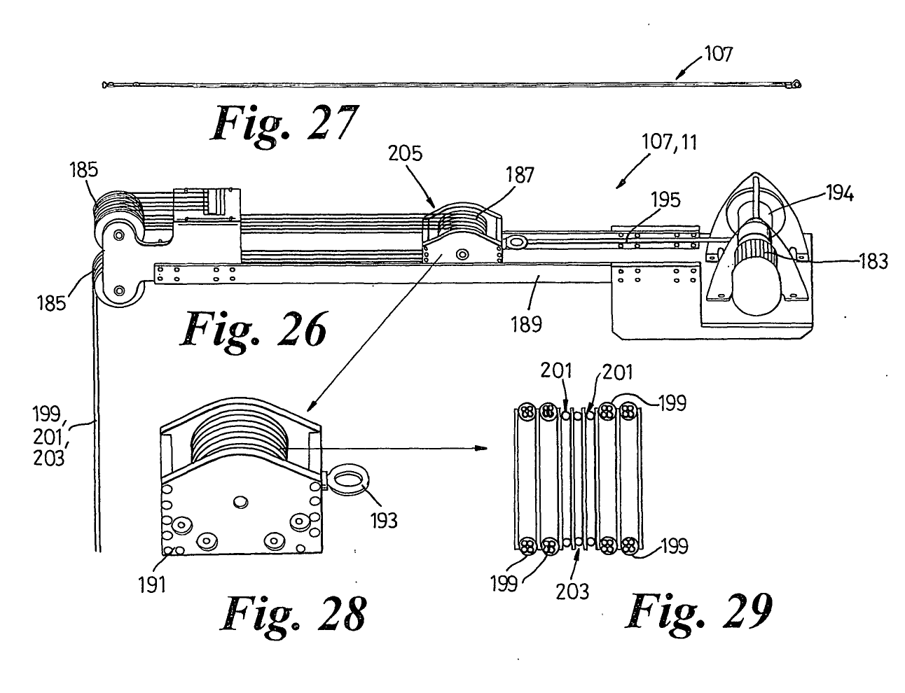

FIG. 29 is a front view of the pulley wheel of FIG. 28;

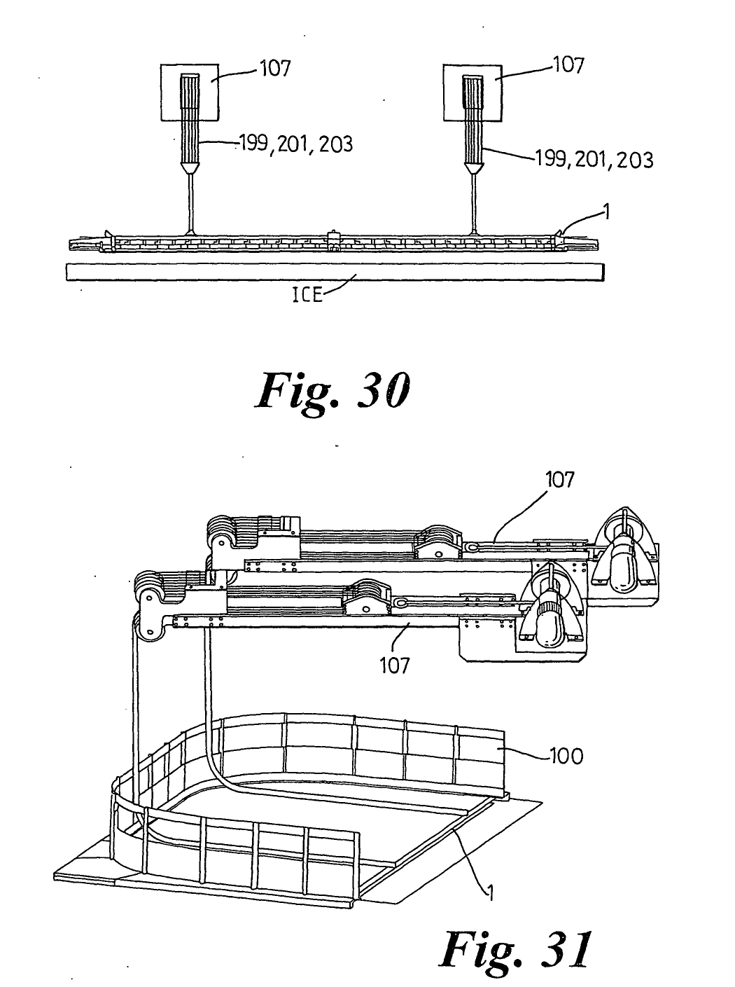

FIG. 30 is a front view of a resurfacing device that has been lowered to an operator position;

FIG. 31 is a diagrammatic view of part of an ice rink the winch assembly, and the boom assembly;

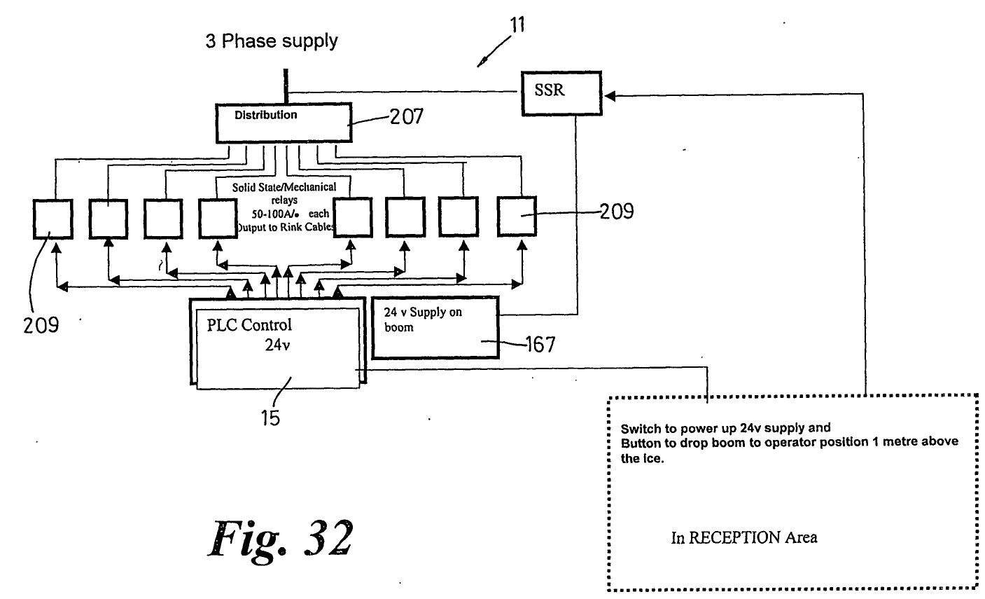

FIG. 32 is a schematic of the power supply system to the boom assembly;

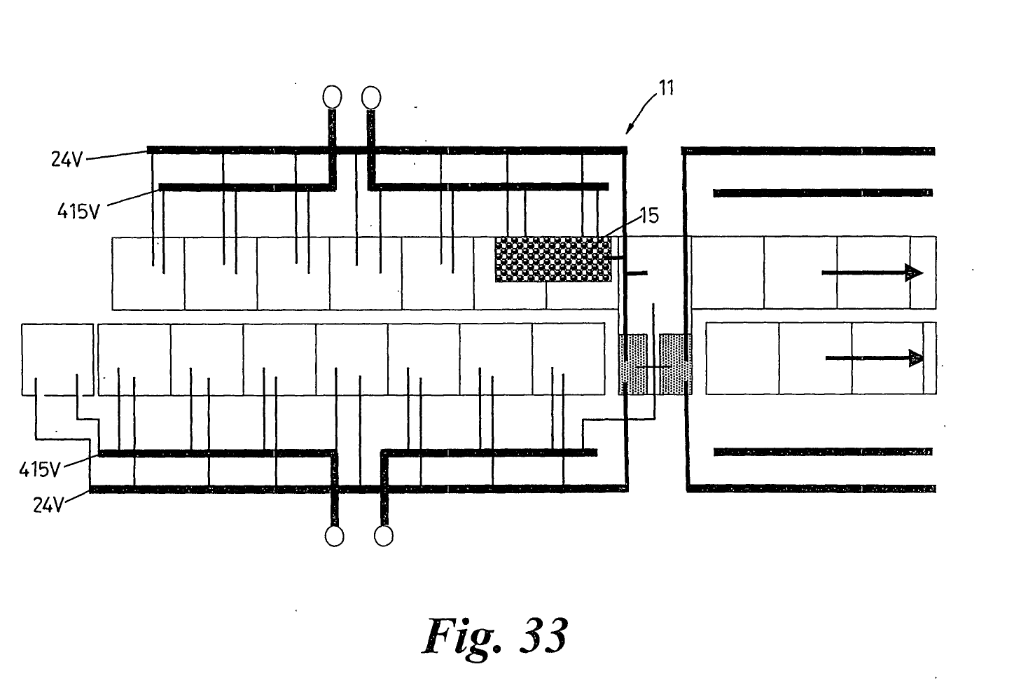

FIG. 33 is a schematic of the power supply system onboard part of the boom assembly;

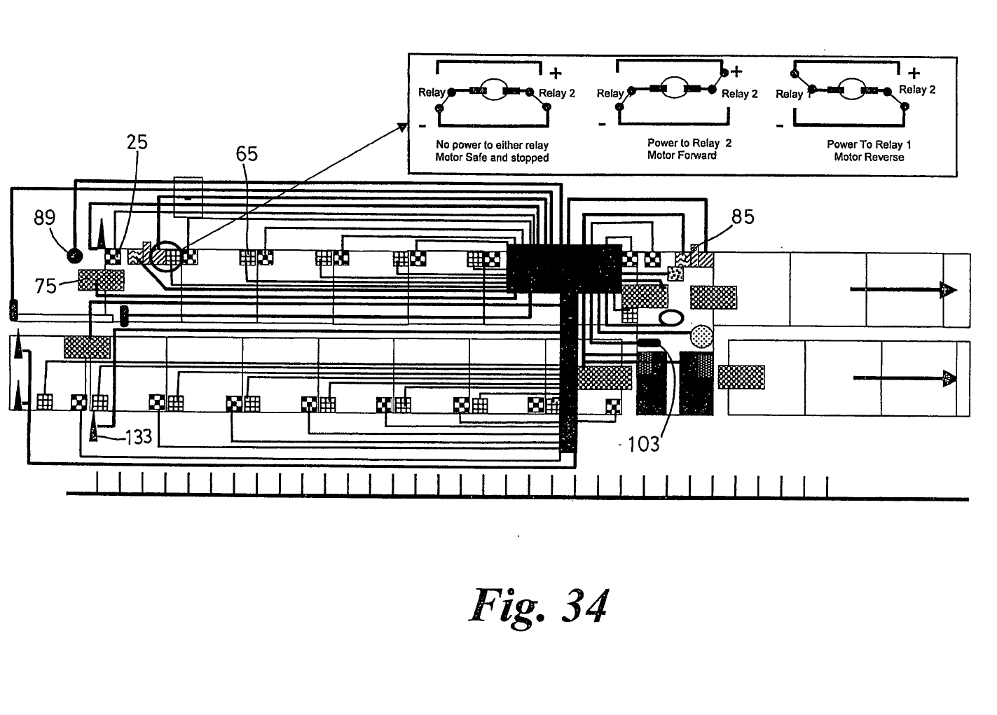

FIG. 34 is a schematic of control circuits onboard part of the boom assembly;

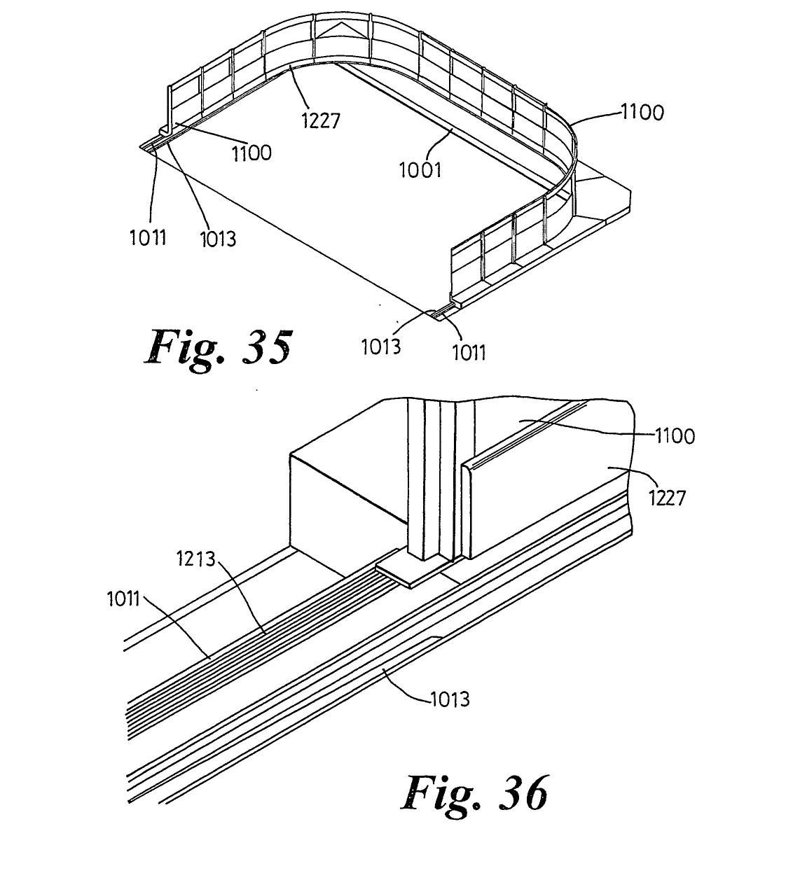

FIG. 35 is a perspective view of a part of an ice rink and a second embodiment of the resurfacing device;

FIG. 36 shows a drive system and power system for the second embodiment;

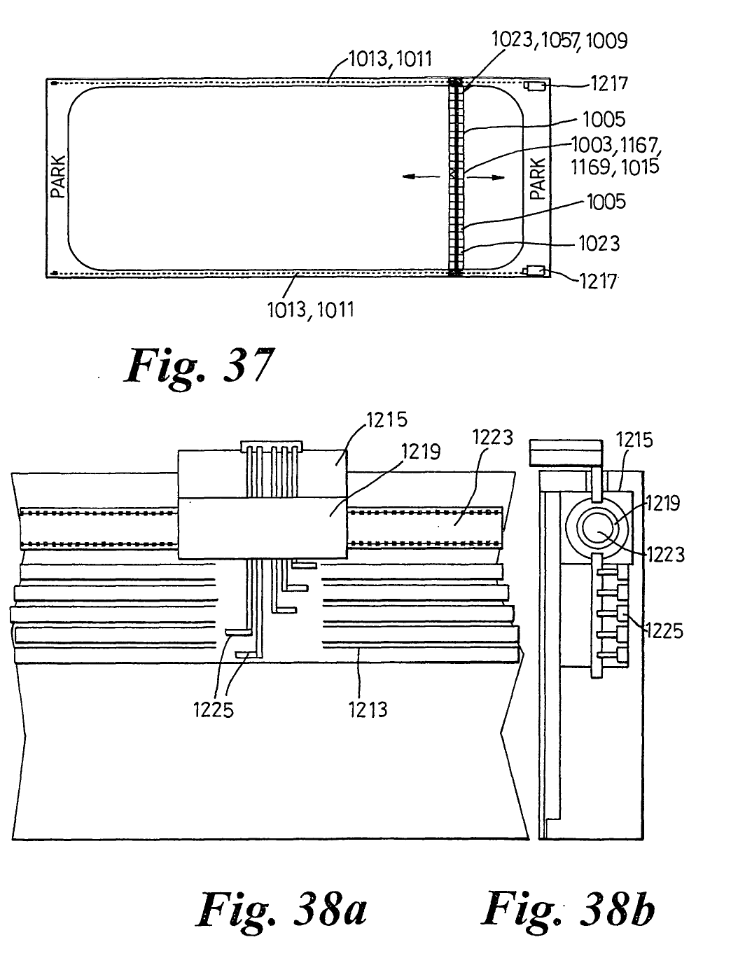

FIG. 37 is a schematic of an ice rink with the second embodiment located thereon;

FIGS. 38a and 38b are schematics of the drive system and power system for the second embodiment;

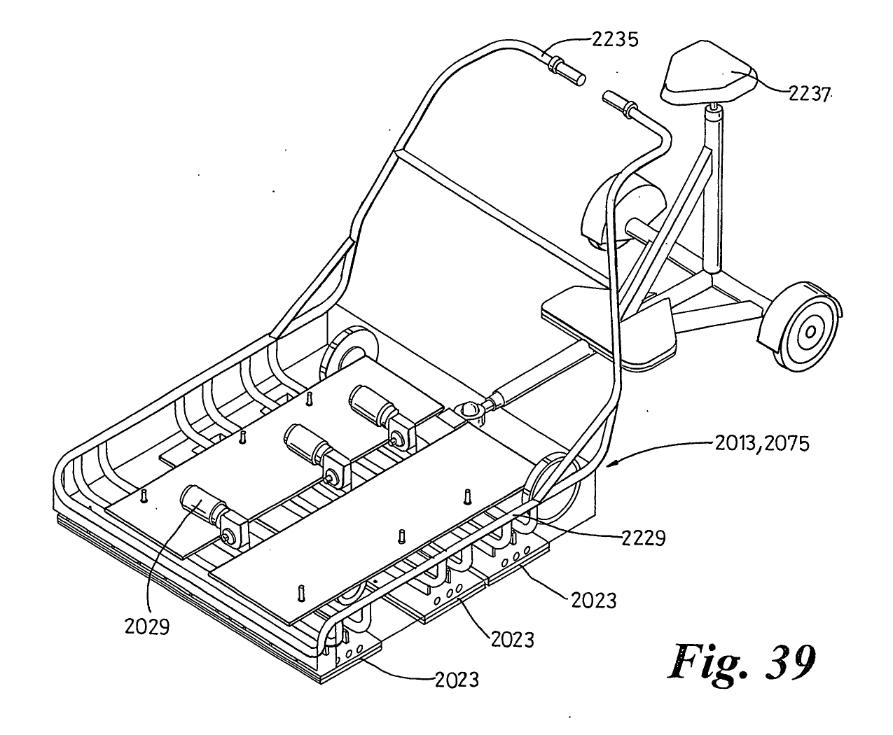

FIG. 39 is a perspective view of a third embodiment of the invention;

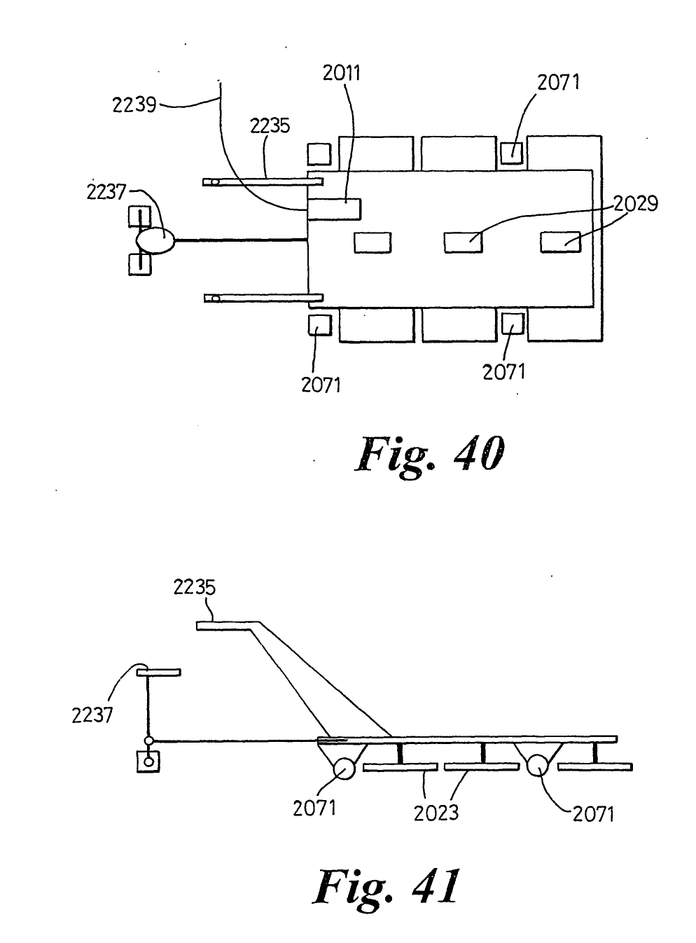

FIG. 40 is a diagrammatic view from above of the third embodiment;

FIG. 41 is a diagrammatic view from the side of the third embodiment;

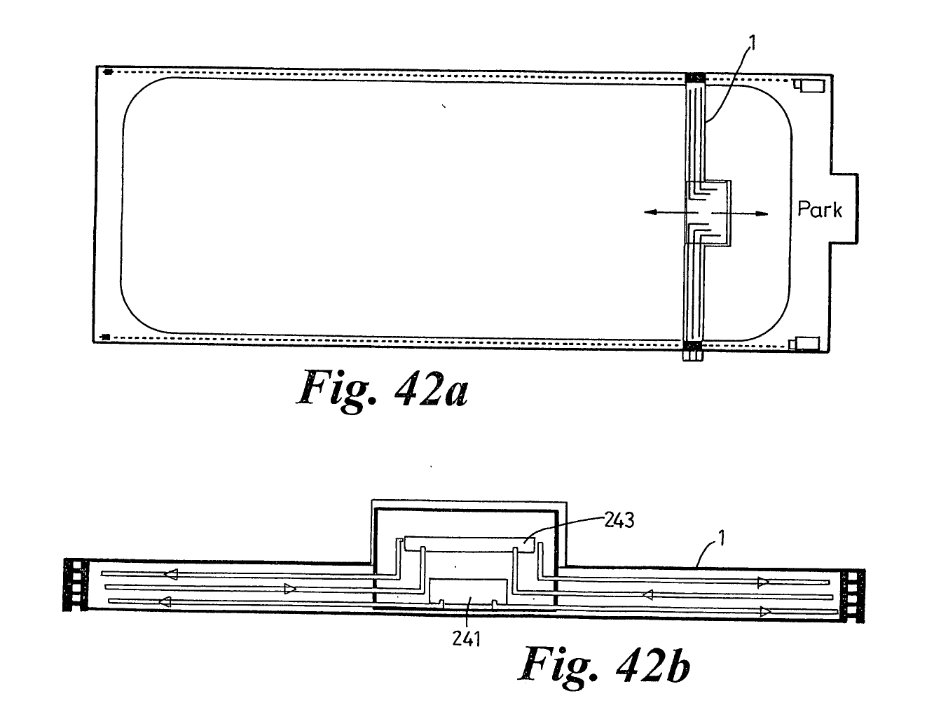

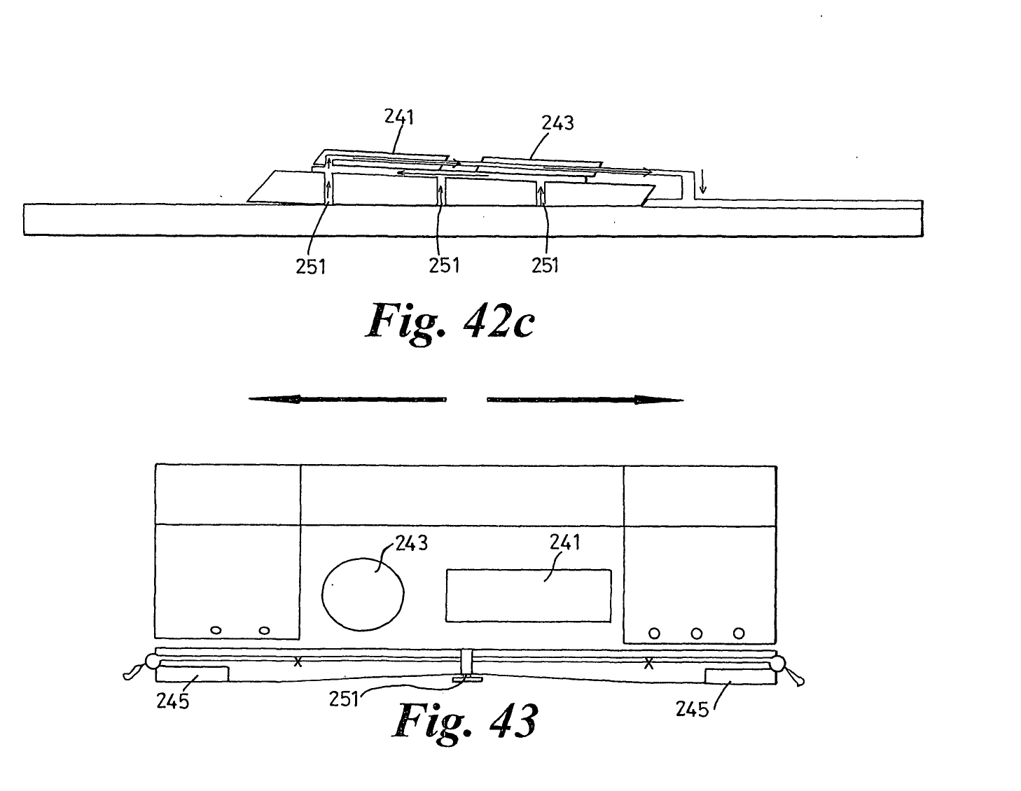

FIGS. 42a-c show diagrammatically a pump and filter system included in the resurfacing device;

FIG. 43 shows diagrammatically an alternative heater module including a pump and filter system;

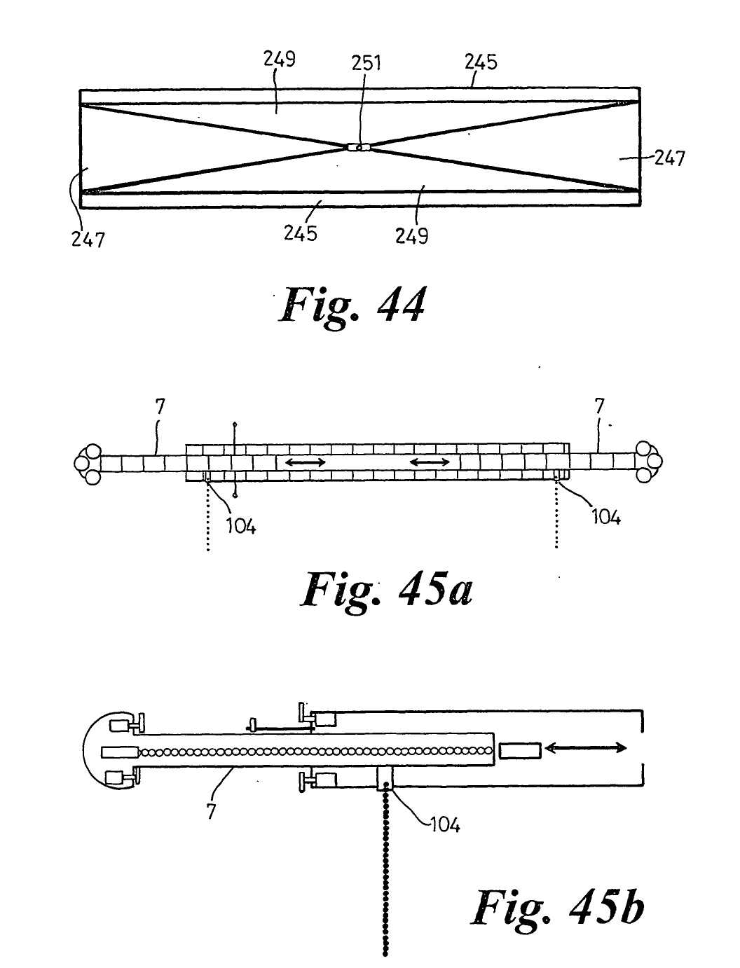

FIG. 44 shows diagrammatically the underside of the alternative heater module;

FIGS. 45a-b show diagrammatically an alternative boom assembly arrangement;

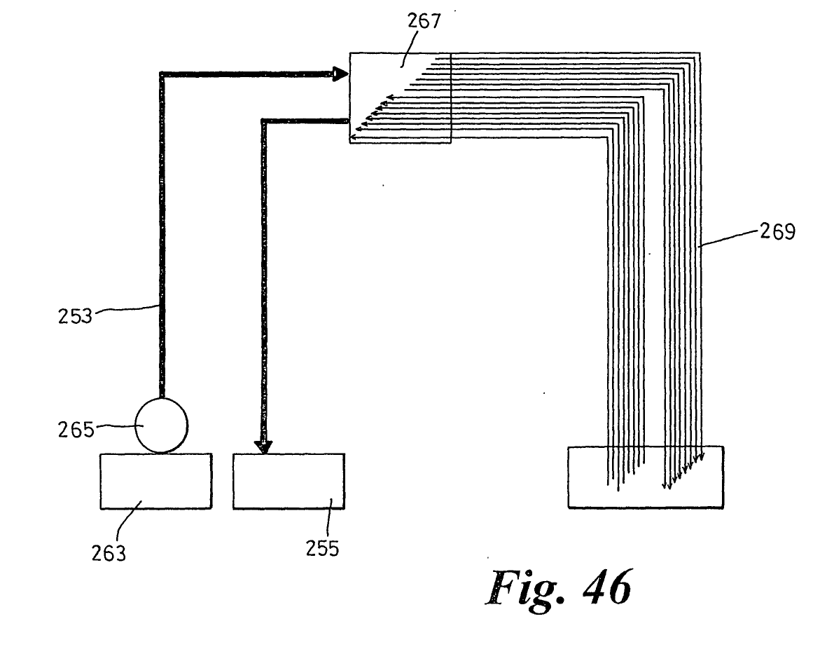

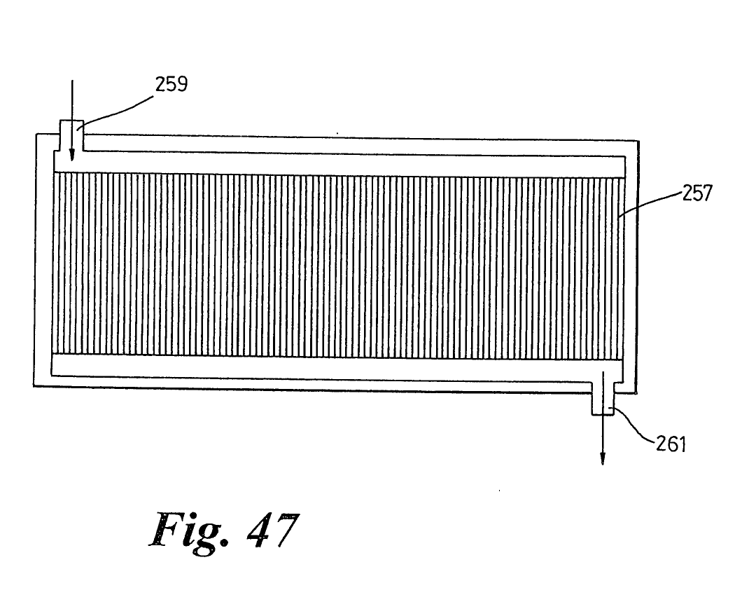

FIG. 46 is a schematic of hot water supply system for heating the heatable plates; and

FIG. 47 is a schematic of an alternative heatable plate adapted to be heated by hot water.

### FIRST EMBODIMENT

FIGS. 1 to 34 show views a first embodiment of the invention.

The device includes an elongate structure, hereinafter referred to as the boom assembly 1 comprising a centre section 3, two fixed sections 5 and two retractable sections 7, each section including at least one heater module 9 for melting the ice, an electrical supply system for powering the device 11, a drive system 13 for moving the boom assembly over the ice and for extending and retracting the retractable boom sections 7, and a Programmable Logic Controller (PLC) 15 for controlling operation of the device.

The fixed sections 5 are attached to opposing sides of the centre section so that they are arranged substantially along the same axis to form the elongate structure. Each retractable section 7 is attached to the rear of one of the fixed sections and is arranged for sliding movement relative to its fixed section 5 (see FIGS. 2 to 3b, which show part of the boom assembly 1 for clarity). Each retractable section 7 is arranged substantially parallel with its fixed section 5, and overlaps the rear face of the fixed section 5. Thus, the boom assembly 1 has a central portion comprising the centre and fixed sections 3,5 which has a defined length, and two retractable sections 7 that are extensible to increase or decrease the overall length of the boom assembly 1. This enables the resurfacing device to adjust its effective length in use so that it can be used to resurface ice rinks where the width of the ice rink varies along the length or width of the rink, for example substantially rectangular rinks having ends with rounded corners.

This arrangement is typically used for existing ice rinks. For new ice rinks that are designed to include an ice resurfacing device of this general type, a simplified version can be used, which is described in more detail below.

Fixed Boom Sections

Each fixed boom section 5 includes an elongate structural member 17, an elongate support member 19, seven heater modules 9, busbars 21 for supplying electrical power to the heater modules 9 and water supply lines (not shown) for supplying water to the heater modules 9.

Each heater module 9 includes, a heatable plate assembly (hereinafter referred to as the heatable plate 23), a three phase solid state relay 25 for supplying power from the busbar to the heatable plate 23, two overload trip switches 27, and a lifting mechanism 29 for adjusting the vertical position of the heatable plate 23 relative to the surface of the ice (see FIGS. 4 to 7). The components of each heater module 9 are mounted on the support member. FIG. 4 shows one fixed and one retractable boom section 5,7 with five heater modules 9 omitted for clarity.

The structural member 17 includes upper and lower lips 31,32 extending longitudinally along the structural member for engaging the support member 19. The support member 19 is substantially I-shaped in section, and is arranged such that the longitudinal axis of the support member is substantially parallel to the structural member 17. The I-shaped section is non-symmetrical and comprises a rear part 33 for engaging the upper and lower lips 31,32 of the structural member and a front part 35 for supporting the lifting mechanism 29, the heatable plate 23, the busbars 21, the three phase solid sate relays 25 and the overload trip switches 27.

Each heatable plate 23 includes upper and lower aluminium plates 37,38, an etched foil heater 39 sandwiched between upper and lower sheets of mica (not shown), a thermal insulating layer 41 comprising a ceramic wool insulating board, electrical connectors 43 for a three phase power supply arranged in delta formation, first and second thermostats 45,46, a water inlet 47, a lifting lug 49 and two guide rods 51 (see FIGS. 8 to 12). The heatable plate 23 has a stratified arrangement. The lower aluminium plate 38 forms the base and the lower surface of that plate is the surface that contacts the ice. The etched foil heater 39 is located directly above the lower aluminium plate 38 and below a ceramic wool insulating board 41. The upper aluminium plate 37 forms the upper layer. The upper and lower aluminium plates 37,38 are bolted together around their peripheries and along two lines extending along the length of the plates parallel to the edges of the plates and positioned at a distance from each longitudinal edge approximately one third of the width of the plates, to firmly secure the assembly.

The etched foil heater 39 is made from a thin sheet of nichrome in the range 100 to 200 microns thick and preferably 180 microns, which is acid etched into the pattern shown in FIG. 8. The heater arrangement shown in FIG. 8 comprises three elements that are connected in three-phase delta formation. The heater is 998 mm long and 230 mm wide and is arranged to extend across the lower aluminium plate 38 so that substantially the entire plate is heated. This means that both the leading and trailing edges of the aluminium plate are heated so that front edge melting occurs regardless of the direction of travel of the resurfacing device. The heater comprises a continuous raster pattern having a path width of approximately 3 mm and spacing of approximately 1 mm. The larger spaces shown in the pattern are to accommodate the bolts, the thermostats 45,46 and a channel to supply water to the lower aluminium plate. Preferably, the etched foil heater is arranged to have a power consumption of approximately 24 kW.

The lower mica sheet is preferably thinner than the upper sheet to more readily facilitate heat transfer to the lower aluminium plate 38, which helps to keep the foil heater 39 relatively cool and thus reduces the risk of overheating. The ceramic wool insulating board 41 is located directly above the upper layer of mica. The insulating board 41 is used to reduce the amount of heat transferred away from the ice.

Operating the heatable plate 23 may cause the upper and lower aluminium plates 35,37 to warp due to the effects of differential heating. The effects of differential heating are mitigated by forming four slots 52 in the underside of the lower aluminium plate (see FIG. 12) and by bracing the upper surface of the upper aluminium plate 37 with two stiffening elements 53 (see FIG. 10). The pattern of slots comprises two pairs of parallel slots that extend transversely across the lower surface of the plate, with each pair being inclined at a few degrees to the leading edge of the plate. The inclination of the slots prevents ridges being formed in the surface of the ice, which could occur if the slots are orthogonal to the leading edge. The slots 52 are arranged to minimise the amount of warping of the lower aluminium plate due to differential heating of the plate. The slots 52 effectively split the lower aluminium plate 38 into sections so that any warping that occurs takes place over the length of a section and not over the full length of the aluminium plate. Optionally, the ends of the lower aluminium plates are also tapered to prevent ridges being formed in the ice between heatable plates 23. Spacers are positioned between the top and bottom plates at each bolt position to conform the lower aluminium plate 38 to the flat shape of the top aluminium plate 37.

Typically, the upper surface of the lower aluminium plate is heated to around 40 C by the heating elements. Since aluminium is a good conductor of thermal energy the heat is transmitted to the lower surface of the plate and then to the upper surface of the ice rink. This causes the ice to melt directly below the plate thus creating a reservoir of water. Any ridges in the ice are melted and the melt runs into any grooves in the ice thereby creating a smooth ice rink surface. The top plate remains at around room temperature due to the layer of insulation. Virtually all of the heat transmitted by the heating elements is transmitted to the ice making the heatable plate 23 a highly efficient means of resurfacing the ice.

The power rating of the heatable plate 23 is 24 kW. Approximately one calorie (4.166 J) per gram is required to raise the temperature of the ice and the melt water by one degree Celsius and 80 calories (333.33 J) per gram to overcome the latent heat of melting. The melting process ensures a proper bond is formed with the underlying ice. The surface ice will normally be between four and seven degrees Celsius below freezing before resurfacing and the melt several degrees above freezing, thus the heat requirement for each gram of ice will be around 100 (416.66 J) calories in total. Therefore, the heatable plate 23 can melt approximately sixty grams per second.

Two holes 55 are formed in the heatable plate 23, one towards each end of the plate to accommodate first and second thermostats 45,46. The thermostats 45,46 monitor the temperature of the foil heater 39. The first thermostat 45 is arranged to detect when the heatable plate 23 is heated to a temperature above a predetermined threshold value. The first thermostat 45 is electrically connected to the overload trip switches 27 which are arranged to cut the power supply to the foil heater 39 should over heating occur. Preferably the first thermostat 45 is set to cut power to the heatable plate 23 if the temperature rises above 80 C. The system then has to be reset. The second thermostat 45 is arranged to detect when the heatable plate 23 cools to a temperature below a predetermined threshold value. Preferably the threshold value is 30 C. When the temperature of the heatable plate 23 falls below the threshold value power is automatically supplied to the foil heater 39.

Electrical power is supplied to the heatable plate 23 via the solid state relay 25. Operation of the solid state relay is controlled by the PLC 15. The supply of power to the solid state relay is described in more detail below.

The heatable plate 23 includes a water inlet 47 and a network of water channels 57 formed in the lower surface of the lower aluminium plate 38 (see FIG. 12). This allows water to be supplied to the heatable plate 23 so that it can be deposited on the surface of the ice, for example at the end of a cleaning cycle or if an ice pad is being made. Water is delivered to the inlet 47 via the water supply line. The water is preferably supplied from a clean water source. This enables the resurfacing device to build up an ice pad from a concrete surface.

The heatable plate 23 is capable of vertical movement between the ice and the support member. The lifting mechanism 29 controls the vertical movement and includes a motor 59, a sprocket 61 mounted on a shaft protruding from the motor, a chain 63 and the guide rods 51. The guide rods 51 extend through two holes formed in the base of the beam and run in vertical linear bearings (not shown) (see FIGS. 5 and 6). One end of the chain is partly wrapped around the sprocket 61 and the other end is attached to the lifting lug 49 that is positioned on the upper surface of the upper aluminium plate. The sprocket 61 rotates approximately one half of one turn in a first direction to lower the heatable plate 23 and rotates approximately one half of one turn in the opposite direction to raise the plate to its maximum height. The lifting mechanism includes relays 65 for selecting the direction of rotation of the motor. Alternatively, a stepping type motor can be used. The operation of the motor is controlled by the PLC 15. The upper stroke is slightly longer than the down stroke so that the motor 59 stalls when the heatable plate 23 reaches it maximum height and engages a stop. This is to establish an upper datum point.

The stall position of the heatable plate 23 can be arranged to squash part of the water supply line to the heatable plate, thereby shutting off the water supply to that plate, so that residual water in the tube does not continue to drip onto the ice.

The linear bearings for the guide rods allow the heatable plate 23 to drop onto the ice under the action of gravity. If a larger amount of ice is to be melted away in a localised area, for example for laying an advertisement below the ice, the heatable plate 23 is free to continue to drop downwards as the ice is melted away until the ice is melted to the desired depth, which may be, for example up to 25 mm. The depth of melt is controlled by the PLC 15.

Optionally, the lifting mechanism can include a spring arrangement (not shown) for tilting the heatable plate 23 such that the leading edge is lifted above the surface of the ice and the trailing edge is in contact with the surface of the ice. This allows the device to be used when there is snow on the surface of the ice, or when the surface is very uneven, such that as the boom assembly 1 is moved over the ice, the snow is trapped beneath the heatable plates 23 and is melted by the plates. The spring loaded tilting mechanism prevents the snow from being pushed along by the leading edge of the heatable plate.

A wheel module 67 is connected to the end of each fixed boom section 5 (see FIGS. 13 and 14). The wheel module 67 includes a support frame 69, two wheels 71 mounted on axles 73 that are carried by the support frame, a drive motor 75 having an encoder for providing the PLC 15 with positional information to control operation of the motor, sprocket 77 and chain arrangement (not shown) for driving the wheels, a rotatable cover 79, a motor 81 arranged to drive the cover, two limit switches 83 for switching off the cover motor, an inductive sensor 85 mounted on the upper surface of the cover, a mechanical proximity sensor 87 for detecting the edge of the ice rink, and an ultrasound sensor 89 for detecting the surface of the ice.

The wheels 71 are generally cylindrical and include thirty two grooves 91 and thirty two teeth 93 alternately distributed about the circumference of the wheel. The grooves 91 and teeth 93 are arranged in parallel and are uniformly distributed about the curved surface of the wheel. The teeth 93 can be formed integrally with the body or can be located in slots formed in the body. Each groove 91 has a U-shaped cross section and each tooth 93 is substantially rectangular in section but includes a concave upper surface 95, thereby forming two ridges 97 along the length of each tooth. The wheels are thus arranged such that they grip the ice when driven by the drive motor 75 about their axes 73 of rotation and are arranged to slide across the ice when the boom 1 is driven in a direction that is orthogonal to the normal direction of motion.

The sprockets 77 are mounted on the wheel axles 73 and on the motor shaft. The sprockets 77 are connected together with a chain (not shown) and drive is transmitted from the drive motor 75 to the wheels 71 via the chain, thus the wheels are driven synchronously. The encoder is connected to the PLC 15 and the output from the encoder is used to control the operation of the drive motor 75, and hence wheels 71.

The cover 79 is arranged to be driven by the cover motor 81 from a first, closed position, wherein the inductive sensor 85 is pointing vertically upwards to an open, operational, position in which the inductive sensor is directed downwards. The limit switches 83 are arranged to switch the cover motor 81 off when the cover has moved to the fully closed and fully open positions. When the inductive sensor 85 is pointing downwards it is able to detect foil strips 99 laid under the ice (see FIG. 15). The foil strips 99 are arranged in three parallel rectilinear tracks 101 extending longitudinally from one end of the rink to the other. The foil strips 99 in each track 101 are spaced apart at 1 m intervals, except the first and final three strips that are spaced apart by one half of one metre. Equivalent foil strips 99 in each track 101 are transversely aligned with each other. The outer tracks are spaced apart such that they are aligned with the inductive sensor 85 in each wheel module. The centre track is arranged to be aligned with a similar inductive sensor located in the centre section 3. Each inductive sensor 85 detects the presence of the foil strips 99 and the depth of ice and sends signals to the PLC 15. An ice depth map is shown in FIG. 23b, which is based on an average of four readings from each inductive sensor 85. This enables the depth of the ice over substantially the full extent of the rink to be determined. The PLC 15 uses this information to determine whether the central portion of the boom assembly 1 is correctly aligned and uses the ice depth information to create an ice depth map of the rink (the inductive sensor in the centre section 3 is not used for alignment purposes). If the PLC 15 determines that the central portion of the boom assembly 1 is misaligned, it controls the operation of the drive motors 75 in the wheel modules 67, which in turn controls operation of the wheels 71, to adjust the speed of one side of the boom to realign the central portion. The arrangement enables the PLC 15 to control the alignment of the boom assembly 1 as it moves across the ice rink. This is a reliable alignment method that is not affected by atmospheric conditions above the ice.

Each fixed boom section 5 includes a transducer 103 for monitoring the alignment of the retractable boom sections 7. The transducer 103 is mounted on an elongate member that extends from the end of the fixed boom section 5. The transducer 103 measures the distance between itself and the retractable boom section 7 and feeds the readings to the PLC 15. The PLC 15 determines whether either of the retractable sections 7 are misaligned and if necessary corrects the misalignment by adjusting the speed of travel of the retractable boom section 7 in the direction of travel of the boom assembly 1.

Alternatively, a system of lasers 104, detectors (see FIGS. 45a-b) and reflectors located on the barrier 100 can be used to measure the alignment of the boom assembly 1 and to send position signals to the PLC 15. The PLC 15 interprets the signals to determine the time of flight and determines whether corrective action is required to realign the boom assembly 1 and powers the drive motors accordingly. This method is accurate to within around 1 mm and obviates the need for foil strips 99 under the ice.

The mechanical proximity sensor 87 is mounted on the support frame 69 and is arranged to detect the barrier 100 that surrounds the ice rink. When the barrier 100 is detected a signal is sent to the PLC 15 to instruct it to cut power to the drive motor 75, thereby halting movement of the boom assembly 1 across the rink.

The ice resurfacing device may be parked at rink level or within the roof space 105 of a building housing the ice rink. In the latter case, the resurfacing device has to be lowered from the roof space 105 on to the rink via a winch assembly 107 (see below) to undertake the resurfacing operation. The ultrasound sensor 89 is arranged to detect the surface of the ice and to send signals to the PLC 15, which in turn controls the operation of the winch assembly so that the descent of the resurfacing device onto the ice can be controlled. A frame support plate 109 is positioned between the wheels 71 and the ultrasound sensor 89. A hole 111 is formed in the plate so that the sensor 89 can detect the surface of the ice.

Retractable Boom Sections

Each retractable boom section 7 includes, an elongate support member 19, seven heater modules 9 similar to those described above for the fixed boom section, an end heater module 113, busbars 21 for supplying electrical power to the heater modules and water supply lines (not shown) for supplying water to the heater modules.

Each retractable boom section 7 is mounted on one of the fixed boom sections 5, substantially parallel thereto, and is arranged for sliding movement relative to the fixed boom section 5 such that the retractable boom section 7 can move longitudinally along the fixed boom 5 thereby extending the effective length of the boom assembly 1. The support member 19 for the retractable boom section 7 is arranged to be carried by the structural member 23 of the fixed boom section 5. The structural member 23 includes upper and lower lips 115,117 that protrude from its rear surface and has bearings mounted thereon arranged to accommodate the sliding movement. The bearings comprise several wheels 119 located in cut away sections in the upper and lower lips (vertical wheels), and wheels 121 mounted on the upper and lower surfaces of the lips (horizontal wheels).

Telescopic movement of the retractable sections 7 is controlled by two motors 123 located in the centre section 3. Each motor 123 drives one of the retractable sections 7 via sprocket 125 and chain arrangements (not shown) (see FIGS. 7 and 21). The chains are maintained by chain guides 127 (see FIGS. 7, 16 and 17). The motors 123 are controlled by the PLC 15. The vertical wheels 119 engage upper and lower inner surfaces of the support member and the horizontal wheels 121 engage vertical inner faces of the support member.

A cable chain 122 is located on the support member 19 of each retractable boom section 7 and is arranged to transfer power from the fixed boom section 5 to the retractable boom section 7 (see FIG. 4).

The end heater module 113 is located at the end of the retractable boom section 7 furthest from the centre section 3 and is the heater module that is moved adjacent the edge of the ice rink being resurfaced. The end heater module 113 includes, a support frame 129 mounted on the support member 19, a heatable end plate 131, a three phase solid state relay 25 for switching power to the heatable end plate 131, two overload trip switches 27, a lifting mechanism 29 for adjusting the vertical position of the heatable end plate 131 relative to the surface of the ice, and a limit switch 133 for detecting the side barrier 100 of the rink (see FIG. 4).

The heatable end plate 131 resembles a truncated arrowhead in plan (see FIG. 18) that comprises a main body part 135 that substantially comprises an elongate trapezium, and a neck part 137 that is substantially rectangular in plan. The heatable end plate 131 is arranged to include a narrow tip 139 so that the curvature of the barrier 100 in the corners of the rink does not prevent an affective heating area to cover the ice in those areas. The width of the heatable end plate at its broadest point is substantially equal to the width of the fixed boom section 5 and the retractable boom section 7.

The heatable end pate 131 is similarly stratified as the heatable plate 23 described above. However, the pattern of the nichrome etched foil heater 141 is different. The pattern comprises three heater elements wired in three-phase delta formation: a central element 143, an inner peripheral element 145 and an outer peripheral element 147.

Each element comprises a different shaped raster pattern as can be seen in FIG. 18. The outer and inner peripheral elements 145,147 extend to the tip 139 of the plate so that heating of the ice can take place immediately adjacent the ice rink barrier 100. The central element 143 is more dense towards the neck 137 and becomes progressively less dense as the element extends towards the tip 139 of the plate.

When the retractable boom sections 7 are extending during operation, the heatable end plates 131 have a significant quantity of ice to melt. The PLC 15 controls the speed that the boom assembly 1 moves across the ice during this phase and the PLC 15 and the power to each heatable plate 23 and heatable end plate 131 in the boom assembly 1 according to its relative motion across the ice. This ensures that the power density delivered by the device is uniform across the whole rink, that is, the power per unit area of ice is substantially uniform. This is important since otherwise the rink would have patches of unfrozen melt water for unacceptably long periods.

The following formula is used for determining the rate of travel in the corner zone, wherein:

x=coordinate axis perpendicular to boom

y=coordinate axis parallel to boom

r=radius of curvature of rounded comer of rink

s=speed at which one end of boom moves in y-direction

v=speed at which boom moves down the rink in x-direction

v_{f}=final speed of boom in the x direction (the set speed for resurfacing), 10 minute resurfacing on a 60 m rink=0.1 m/sec.

t=time; t=0 is at the instant the boom begins moving

y₀=initial length of half the boom, at t=0

y_{f}=final length of half the boom, or half the width of the rink
y_{f}=y₀+r
Geometry

The geometry is shown in FIG. 18b. The system is symmetrical about the x-axis.

The end of the boom traces a ¼ circle with radius r and centre (r, y₀). The equation of the circle is
(x−r)²+(y−y₀)²=r²

We want to find v, which is the instantaneous speed in the x-direction, or v=dx/dt. Using implicit differentiation with respect to time:

$$2 ( x - r ) \frac{ⅆ x}{ⅆ t} + 2 ( y - {y}_{0} ) \frac{ⅆ y}{ⅆ t} = 0$$

$$or$$

$$\frac{ⅆ x}{ⅆ t} = - \frac{( y - {y}_{0} )}{( x - r )} \frac{ⅆ y}{ⅆ t}$$

The quantity dy/dt is the speed in the y-direction, so dy/dt=s; therefore

$$v = - \frac{( y - {y}_{0} ) s}{( x - r )}$$

From the equation of the circle:
x−r=±√[r²−(y−y₀)²]

From the figure above, we see that x<r, so x−r is negative, so use the negative radical.

$$v = \frac{( y - {y}_{0} ) s}{√ [ {r}^{2} - {( y - {y}_{0} )}^{2} ]}$$

This is the equation for v as a function of y, which is half the instantaneous length of the boom.

To find the equation of v as a function of x (distance from starting position of boom), start with the equation of the circle and find y:
y−y₀=±√[r²−(x−r)²]

From the figure, we see that y>y₀, so y−y₀ is positive, so use the positive radical. Substitute into the dx/dt equation:

$$\frac{ⅆ x}{ⅆ t} = - \frac{√ [ {r}^{2} - {( x - r )}^{2} ] * \frac{ⅆ y}{ⅆ t}}{( x - r )}$$

$$or since s = \frac{ⅆ y}{ⅆ t} \text{:}$$

$$v = \frac{s * √ [ {r}^{2} - {( x - r )}^{2} ]}{( r - x )} or v = \frac{s * √ [ {r}^{2} - {( r - x )}^{2} ]}{( r - x )}$$

This is the equation for v as a function of x, which is the distance the boom assembly 1 has travelled down the rink.

To find the equation of v as a function of time, start with the equation of motion in the y-direction:
y=y₀+dy/dt*t or y−y₀=st

Substitute into the equation for v:

$$v = \frac{{s}^{2} t}{√ [ {r}^{2} - {( st )}^{2} ]}$$

This is the equation for v as a function of time.

An example calculation for v as a function of x can be found in the table 1 below:

CORNER PROBLEM BOOM SYSTEM

| | |
|---|---|
| Radius of corner r (m) (constant for the rink) | 8 |
| x distance (must be less than r) (m) | 4.43 |
| Speed of one boom end in y-direc, s (m/s), | 0.1 |
| (set from control file) | |
| Speed that boom moves down rink, v (m/s) | 0.200539684 |

The velocity of the expanding boom in the y direction (s) is constant and should be obtained from the control (master variables) file, as it may need changing from time to time. 0.05 to 0.4 m/s should be an adequate range for this.

Solving the above equation gives us v for any time t or more usefully the equation above it for any distance in the x direction.

If v_{f} (the final speed of the boom at x=r) is set to 0.1 m/sec then this is the maximum speed the boom can move in the x direction.

For any s, the v satisfying the formula will be greater than v_{f} at some point then as this is not allowed by definition, boom will run into the side wall of the rink, it is at this point that the end limit switches take over, the boom will continue to move down the rink at v_{f} and the lateral movement of the boom will be according to the limit switches (see final drawing).

s should not be set too fast or v>v_{f} will occur too early and before the limit switches become effective. Thus if s is set to 0.1 m/s and v_{f} m/s is set 0.1 the limit switches will take over at approximately x=2.4 m and this is probably too soon for the limit switches to trigger properly, the angle being too acute.

If s set to 0.05 then the takeover point will be at 4.5 m which is much better.

The power into the individual elements can be regulated with the On/Off ratio technique. The average power into the elements on the fixed part of the boom is:

$$\frac{v * Watts}{{v}_{f}}$$

(at any instant of time)

But on the retractable boom 7 the situation is more difficult as the plates are moving at a variable angle across the ice but the more acute the angle the longer the travel of any one point on the ice under the hot plate and these two effects will tend to cancel themselves out. As x approaches r the power requirements of the telescoping elements with be the same as that of the fixed elements as they will all be moving in the same direction.

The power input to the heatable plates 23 can be adjusted independently, the power settings can then be tailored to achieve approximately equal melting over each unit square area of the ice surface. The on times of the heatable plates 23,1311 have to pole around so the resistive load on the cable and power supply is averaged.

The heatable end plate 131 includes first and second thermostats 45,46 arranged to ensure that the plate operates within the correct temperature range (30 C to 80 C), an arrangement of slots 149 and stiffening elements 151 to prevent the plate from warping due to differential heating, two water supply inlets 47 and a network of water channels 153 for the delivery of clean water to the ice rink. Some of the water channels 153 are preferably located in the slots 149.

The arrangement and operation of the seven heater modules 9 of the retractable boom section 7 is similar to the heater modules 9 of the fixed boom sections 5, and will not be further described.

The limit switch 133 is arranged to detect the presence of the barrier 100 surrounding the ice rink. The switch 133 is electrically connected to the PLC 15. When the barrier 100 is detected a signal is sent to the PLC 15 that switches off the motor 123 driving the retractable boom section 7 into its extended state. Inductive sensors 155 are located on the sides of the centre section 3 and are arranged to detect the position of the retractable section 7 as it approaches the centre section 3 (FIG. 23a). The inductive sensors 155 are connected to the PLC 15 and the PLC 15 is arranged to switch off the motor 123 when the boom sections are fully retracted. Additional inductive sensors 157 are mounted towards the ends of the fixed boom sections and are arranged to detect when each heatable plate 23 passes the end of the fixed boom sections (see FIG. 23a). The sensors 157 are connected to the PLC 15 and the PLC 15 determines when each heatable plate 23 should be lowered onto the ice to begin resurfacing.

Each retractable boom section 7 includes two wheel modules 159: one set located towards each end of the boom (see FIG. 3). One of the wheel modules is located between the final heater module 9 and the end heater module 113. The neck portion 137 of the heatable end plate 131 is located between the wheels 71 in that module. The wheel modules are similar to those described above however the modules 159 do not include the inductive or ultrasound sensors 85,89, the cover 79, the cover motor 81 or limit switches 83. The wheel module 159 adjacent the end heater module 113 includes a mechanical proximity sensor 87 for detecting the barrier 100 at the end of the rink (see FIGS. 13 and 23).

Of course, it is only necessary to have a resurfacing device with retractable boom sections 7 when the width of the ice rink is variable. If this is not the case, for example if the rink or track is rectangular then the telescopic sections could be omitted and additional heater modules 9 included in the fixed boom sections 5. In this instance it may be necessary to include additional wheel modules. The retractable boom sections 7 can also be omitted if the rink is designed to include a resurfacing device of this type from the outset whether or not the width of the rink varies along its length (see second embodiment below).

The length of the boom assembly 1 and the number of heater modules 9 included in the fixed and retractable boom sections 7 depends upon the width of the ice rink/track to be resurfaced. In practice it is necessary for each boom section to include at least one heater module 9, but may include any practicable number. The arrangement shown in FIGS. 1 to 4 is configured to resurface an ice rink having a width of approximately 30 m. This includes twenty eight heater modules 9 and two end heater modules 113. The dimensions and power rating of any given module can be adapted for a particular rink or track. Ideally, the resurfacing device is arranged to stretch across the width, or length as appropriate, of the rink/track so that resurfacing can be undertaken smoothly and uniformly, in a single pass if sufficient power is available. This prevents ridges being formed in the surface similar to those produced by scraping machines and burners.

The boom assembly 1 also includes edge pressure sensors 161 that are connected to the PLC 15 and arranged to arrest movement of the boom assembly 1 if the pressure sensors 161 detect the presence of any objects or obstacles located on the surface of the ice (see FIG. 23a). The edge pressure sensors 161 can be located on both the fixed and/or the retractable boom sections 5,7. FIG. 23a shows schematically the arrangement of input output devices on the boom assembly 1.

The Centre Section

The centre section 3 includes a heatable centre plate 163, a lifting mechanism 29 for controlling the vertical position of the heatable centre plate, the PLC 15, a Human Machine Interface (HMI) 165 for the PLC 15, four wheels 71, two drive motors 75 for driving the wheels, each having an encoder for supplying positional information to the PLC 15 to control operation of the motors, two motors for driving the retractable boom sections 123, each motor having an encoder for supplying positional information to the PLC 15 to control operation of the motors, a cover 79 with an inductive sensor 85 located on its upper surface, a cover motor 81 for moving the cover between closed and open positions, two limit switches 83 for switching the cover motor off when the cover has moved to either the closed or open positions, and at least one 24V rechargeable cell 167 and a charger unit 169 for recharging the cell for powering the PLC 15, HMI, all of the sensors and motors on the boom assembly 1. The centre section 3 also includes an automatic water flow controller 171 for controlling the flow of clean water to the water channels formed in the heatable plates 23 for distribution during a cleaning operation.

The lifting mechanism 29, motor driven wheels 71, the cover 79, cover motor 81, limit switches 83 and inductive sensor 85 are arranged and function similarly to the equivalent components for the fixed boom section 5 described above, and will not be further described.

The heatable centre plate 163 is rectangular in plan but is smaller than the heatable plates 23 used in the heater modules 9 (see FIG. 22). It is has a similar stratified structure to the other heatable plates 23 however the pattern of the nichrome etched foil heater 173 is different. The pattern comprises three similar substantially rectangular heater elements 175 wired in three phase star formation. The elements 175 extend longitudinally along the plate and are arranged substantially parallel.

The heatable centre plate 163 includes first and second thermostats 45,46 arranged to ensure that the plate operates within the correct temperature range (30 C to 80 C), and an arrangement of slots 177 and stiffening elements 179 to prevent the plate from warping due to differential heating, and may include a water supply inlet 47 and an arrangement of water channels 181 for the delivery of clean water to the ice rink.

The PLC 15 controls the entire operation of the resurfacing device. It is arranged to receive signals from all of the sensors and limit switches, to send control signals to all motors, the solid state relays for controlling the amount of heat generated by the heatable plates 23 and the automatic water flow controller 171 to control the amount of water that issues from the water channels onto the surface of the ice. The HMI 165 enables an operator to select between different resurfacing programs (see FIG. 24a), for example normal resurfacing operation 165a where ice is melted and allowed to refreeze, a cleaning operation 165b where the ice is melted in a first pass and melt water is removed from the surface of the rink by a wet vacuuming machine that follows behind the resurfacing device and then new clean water is distributed over the rink in a second pass, night routine 165c for use of cheap electricity, ice depth measurement routine for measuring the depth of the ice across the rink, ice thickness adjusting routine 165d, advertising routines 165e where the depth of the ice is reduced in a localised area by only lowering certain heatable plates on to the ice so that adverts can be placed below the surface of the ice. The ice layer is built up over the advertisement, using the lay ice by layers routine 165f. Advertisements can be located in any place except along the wheel lines 166 and along the longitudinal edges of the rink (see FIG. 24b). FIG. 24c shows several heatable plates 23 melting the ice in a localised area for laying an advertisement below the ice. The other heatable plates 23 are raised above the surface of the ice.

For each programme the operator inputs values for variables such as time, size of rink, radius of curvature of corners, available power to heatable plates 23, depth of resurface, delays between cycles, flow rate of water. The PLC 15 uses algorithms to determine the actual operation of the resurfacing device, for example the PLC 15 may calculate the resurfacing depth, replacement run time after cleaning and the rate of travel in a corner zone.

The automatic flow controller controls the flow rate of water to the heatable plates 23 during cleaning routines. The flow rate is measured in litres per minute and is constant for a particular rink. For example, a 60 m by 30 m rink will have a flow rate of around 18 litres per minute.

The resurfacing device can be parked in the roof space 105 of a building housing the ice rink or at rink level, for example at one end of the rink behind the rink barrier 100. When the device is arranged to be parked in the roof space 105, it is preferred to lower the device from the roof space via the winch assembly 107. Power can be supplied from busbars (not shown) located in the roof space 105 that extend along the length of the ice rink. However, this is only possible if the space above the rink does not have any obstacles, such as wires that extend across the rink, which is commonly the case, since these would interfere with the cables connected to the boom assembly 1.

An alternative power supply 11 and winch assembly 107 is shown in FIGS. 25 to 32 that can be used to control the vertical position of the resurfacing device and supply power to the device even when there are obstacles above the ice rink. The system comprises two identical winch assemblies 107 that are mounted in the roof space 105, each assembly having a winch motor 183, two fixed pulley wheels 185, one moveable pulley wheel 187 and an elongate trough 189. The trough 189 is typically around 40 m long for a 60 m long ice rink and is arranged horizontal and parallel to the edge of the ice rink. The moveable pulley wheel 187 is mounted in a frame 191 that is arranged to slide along the trough 189 (see FIG. 26). The frame 191 has an anchor 193 attached to one wall. A lifting cable 195 connects the anchor 193 to a drum 194 mounted on a shaft (not shown) protruding from the winch motor 183. The winch motor 183 is mounted at one end of the trough.

The fixed pulley wheels 185 are mounted in a frame 197 that is fixed to the other end of the trough (see FIG. 26). The fixed pulley wheels 185 are arranged one above the other and are arranged to rotate about axes that are substantially parallel to one another and orthogonal to the longitudinal axis of the trough.

All of the pulley wheels have seven grooves formed in their curved surfaces that extend around the circumference of the pulley wheels (see FIG. 29). Four of the grooves are arranged to receive electrical power cables 199 for supplying electrical energy to the boom 1, two grooves are arranged to receive control cables 201 for send control signals between the PLC 15 and the winch motor 183 and one of the grooves is arranged to receive a Vectran® lifting rope 203. The Vectran® lifting rope 203 is located in the centre groove, the two control cables 201 are located in the two grooves adjacent the centre groove and the power cables 199 are located in the reaming grooves.

The cables are anchored in the fixed frame 197 and are wrapped over the upper fixed pulley wheel attached to the fixed frame, thereby turning through 180 degrees. The cables extend along the trough 189 and are wrapped over the moveable pulley wheel 187, turning through 180 degrees and extending back along the trough 189 and over the lower fixed pulley wheel attached to the fixed frame. The cables extend from there to an anchor point on the boom assembly 1 (see FIG. 26).

The resurfacing device is raised and lowered by controlling the operation of the winch motor 183. When the motor 183 rotates in a first direction, the drum 194 mounted on the motor shaft is caused to rotate thereby paying out the lifting cable 195. The moveable pulley wheel 187 slides along the trough 189 and the power cables 199, control cables 201 and the Vectran® rope 203 are lowered towards the ice with the resurfacing device. An inductive sensor 205 is mounted on the frame 191 to ensure that cable payout is even. The sensor 205 detects holes (not shown) formed within the base of the trough 189 and the PLC 15 determines the location of the pulley wheel 187 within the trough 189 and hence the position of the resurfacing device above the ice. Optionally, a tilt switch (not shown) can be included to halt the lowering process when the boom assembly 1 is not substantially horizontal. As the resurfacing device approaches a predetermined distance above the surface of the ice (so called operator position, see FIG. 30), the ultrasound sensors 89 send a signal to the PLC 15. The PLC 15 then sends a control signal to the winch motor 183 that halts the descent of the resurfacing device. An operator can then use the HMI 165 to select a routine. When initiated the PLC 15 sends a control signal to the winch motor 183 to slowly lower the resurfacing device onto the ice. If no routine is selected, the PLC 15 may be programmed to initiate a normal resurfacing operation or to return to the park position.

As the resurfacing device moves across the ice performing the selected routine, the winch motor 183 continues to payout cabling which lies across the ice behind the boom assembly 1 (see FIG. 31). This arrangement allows the resurfacing device to move across the ice without the cabling interfering with any obstacles located above the rink. The inductive sensors 205 mounted in the roof space ensure that the cable payout is even and that it is equal to the movement of the boom assembly 1 across the ice. The resurfacing process is stopped if the cable payout is uneven.

When the operation has finished. The operator selects the “return boom to roof space” option. The boom moves across the ice to the start position and the winch motor 183 rotates in the opposite direction to retract the cables. When the boom reaches the start position, it is lifted off the ice and returned to its park position in the roof space 105. The weight of the boom assembly 1 described (i.e. with twenty eight heater modules 9, two end modules 113 and a centre section 3) is approximately 1200 Kg and the lifting arrangement is a 2:1 pulley system.

Three phase electrical energy is supplied to the power cables via a distribution panel 207 and eight 50 to 100A solid state relays 209 located in the roof space 105 (see FIG. 32). The distribution panel 207 has a three phase 350 kW supply. Power is supplied to the resurfacing device as a three phase 415V power supply. This supply powers the heatable plates 23 via the busbars 21 and the solid state relays 25 located in the heater modules 9 and the cell charger 169. The charger 169 recharges the cell 167 that provides a 24V for electrical components mounted on the boom. FIG. 33 shows schematically how power is distributed to the electrical equipment mounted on the boom assembly 1. The 24V cell 167 supplies a 24V signal to all motors and sensors in the assembly via the 24V busbar 21 and to the PLC 15. The three phase 415V supply supplies power to all of the heatable plates 23 and the cell charger 169 via the 415V busbar 21. FIG. 34 shows schematically the sensors, motors and limit switches mounted on the boom assembly 1 connected to the PLC 15, thereby defining the control circuits.

Most rinks will have the capacity to supply at least 250 kW for resurfacing. Some of this power can be made available from the refrigeration plant for the period required for resurfacing. At these power levels very rapid resurfacing can be achieved, for example between 5 to 10 minutes for a 60 m by 30 m ice rink, depending on the depth required. The depth required depends on the quality of the surface. The PLC 15 determines the speed that the boom assembly 1 needs to move across the ice rink to melt the ice to the desired depth for a given power supply. The PLC 15 continuously calculates the required speed to account for power fluctuations, and the effects of the retractable boom sections 7 retracting or extending, and controls the drive system 13 accordingly. For example, if all the heatable plates 23,131,163 have a 24 kW rating, the total power requirement will be 744 kW. If only 250 kW of power is available this is an average of 8 kW per plate and therefore the plates must be switched on and off via the solid state relays 25 serving the heatable plates 23,131,163 such that the instantaneous power required is substantially less than the power rating. The on/off sequence can be rotated around all the heatable plates 23,131,163, so the continuous power draw from the supply is constant. Having over rated plates and the ability to cycle the application of power to those plates helps produce a uniform amount of power delivered per unit area of ice to achieve substantially uniform melting.

To resurface the top 1.00 mm of an Olympic rink it is necessary to melt of 1.8 cubic metres of ice, which requires 7.5×10⁸ joules of energy and produces 1,800 litres of water. If this depth of resurfacing is to be completed in one hour then at least 200 kW of electrical power must be available. This represents 200 units (kWh) of electrical power. This is a very deep resurface, which may be required for very damaged or polluted ice periodically. This type of operation is known as a cleaning routine and will also require the melt water to be replaced with fresh water. The melt water is removed by a wet vacuuming machine following behind the boom assembly 1.

The resurfacing device includes a series of control switches (not shown) including an emergency switch that cuts all the three phase supply except the 24V supply; an abort switch that takes the boom back to the operator position, lifts all the heaters and cuts the three phase supply to the heaters; a heater switch lifts all the heaters with no reference to the PLC 15; a retract switch that lifts all of the heaters and telescopes the booms in without reference to PLC 15; forward and backwards switches for driving the boom forwards or backwards whilst the switch is depressed without reference to PLC 15; and a pause switch for lifting heaters off the ice, stopping the boom and water flow. The operator can use the HMI 165 to return the resurfacing device back to its park position.

The operation of the resurfacing device will now be described for standard resurfacing and cleaning routines.

Standard Resurfacing Operation

The operator lowers the resurfacing device from the roof space 105 via a control panel located in a reception area. The boom assembly 1 lowers to the operator position, which is approximately 1 m above the surface of the ice (see FIG. 30). The operator then selects the standard resurfacing operation 165a or the device is automatically initiated with default settings after a preset delay if no input is made (see FIG. 24a). Alternatively, the operator can select the time available to resurface the rink, the number of cycles the boom assembly 1 should perform and the delay between cycles. The PLC 15 then calculates the depth of resurfacing that will be obtained and displays it to the operator. The operator then initiates the device and the following sequence occurs:

1. The PLC 15 switches on all the heatable plates 23,131,163 and starts the wheels rotating 71 at 5 rpm. Power is supplied to each heatable plate 23,131,163 is controlled by a switching arrangement that opens and closes according to the temperature of the plate. The switch is set to open at around 80 C and close again at 65 C. 12 kW is supplied to the twenty eight standard heatable plates 23, 24 kW to the heatable end plates 131 and 6 kW the heatable centre plate 163. This means that the total power supplied to the heaters is 390 kW. If this is more power than the rink has available for the resurfacing operation the maximum current, and hence power, supplied is limited by a background cycling interruption of the current to each heater module. For example, if a rink has only 300 kW available then any one heater module can be switched on four three quarters of the of the time in the cycle. The gap in supply is rapidly cycled around all the heater modules so the reduced current draw is smooth. The heatable plates 23,131,163 are in the raised position.

2. There is a delay of 10 seconds to allow the operator to clear the boom assembly 1.

3. The boom assembly 1 is then lowered onto the surface of the ice from the operator position, with decreasing speed for the last 20 cm for a gentle touch down. The descent is controlled by the PLC 15 using the inputs received from the ultrasound sensors 89.

4. The PLC 15 accelerates the boom assembly 1 to a speed that allows the heatable plates 23,131,163 time to reach 80 C before arriving at the closest end barrier 100 (arrived at experimentally for each rink and stored in a control file). The end barrier 100 is the start position and acts as an initial datum for the device.

5. When boom assembly 1 is close to the end barrier 100, the PLC 15 slows the drive motors 75 on both sides of the boom independently according to readings taken from the proximity sensors on each fixed boom section 5 so that the device starts resurfacing exactly parallel to the end barrier 100. However, the boom assembly 1 is not allowed to stop completely and melt into the ice.

6. The heatable plates 23,163 on the fixed boom sections and the centre section 3 are lowered onto the surface of the ice and the device starts resurfacing when the plates contact the ice. The device begins to move away from the end barrier 100 across the rink and the heatable plates melt the ice to the required depth as the boom moves over the ice. The power delivered to the plates and the speed of the boom assembly 1 are controlled by the PLC 15 to control the depth of resurfacing. The power cabling is dropped onto the ice behind the boom assembly 1.

7. The retractable boom sections 7 are then deployed. As deployment occurs, the heatable end plates 131 and standard heatable plates 23 are lowered onto the ice according to feedback from the inductive sensors 157 at the end of each fixed boom. Each heatable plate 23 is only lowered onto the surface of the ice when it passes the end of the fixed section 5.

8. The retractable boom sections 7 extend at the resurfacing speed. The forward speed of the device is calculated according to a predetermined formula. The power applied to the heatable plates 23,131 on each retractable boom section is 100% of the available power and the power applied to the heatable plates on the fixed boom sections and the centre section 3 is less than 100% and is calculated by multiplying the maximum available power by a factor expressed as a mark/space ratio (determined by the power supply ratio:time on/time off) when power is cycled to the heatable plates 23.

9. The limit switches 133 on the retractable boom sections detect the presence of the side barrier 100 and cease deployment. Since the curvature of the side barrier 100 extends away from the tip 139 of the heatable end plate 131, each retractable bloom section is further deployed as the boom moves forward when the limit switch no longer detects the barrier 100. Deployment ceases when the limit switch detects the barrier 100 again. This process continues until the ends of the corners, wherein the retractable boom sections will be deployed to the full width of the rink. The tips 139 of the heatable end plates are designed to melt the ice adjacent the edges of the rink so that a separate edging process is not required.

10. Each inductive sensor 85 is lowered to its operational position within one half of one metre of travel so that they can detect the foil strip tracks 101 located beneath the ice and measure the depth of the ice. The inductive sensors 85 detect the foil strips and send the appropriate signals to the PLC 15. If the inductive sensors 85 mounted on the fixed boom sections detect foil strips 99 unevenly then one of the inductive sensors is used as a fixed control with a constant rpm at the resurfacing rate, and the other inductive sensor is used to slow or speed up the drive motor 75 on the opposite side to bring the boom assembly 1 back into alignment by the next row of foil strips. At the next row of foil strips, the process repeats itself so that the PLC 15 is continually controlling the alignment of the boom assembly 1 as it moves across the ice. The ice is melted as the boom assembly 1 moves over the rink.

11. When the limit switches 133 of the retractable boom sections detect the curved barrier 100 towards the other end of the rink, the retractable boom sections begin to retract as the boom assembly 1 moves forwards since the width of the rink decreases with the curvature of the barrier 100, until the end of the corner, wherein the boom assembly 1 has reached the opposite end barrier 100 which is detected by the inductive sensors 155. The mechanical proximity sensors detect 87 the barrier 100 and send signals to the PLC 15 to arrest movement of the boom assembly 1.

12. When completing the first run, and arriving at the barrier 100 opposite the start position, the retractable boom sections are fully retracted and the boom assembly 1 aligns itself with the barrier 100 using the mechanical proximity sensors 87 on the front of the boom assembly 1. The heatable plates are lifted from the ice and are switched off if no further cycles are required and the boom returns at full speed, preferably in the retracted state, to the lift up point using the winch inductive sensors 205 to maintain alignment. The three inductive sensors 85 for detecting the foil strips run just behind the boom and are only lowered onto the ice after the boom has moved away from the barrier. The cover limit switches 83 determine both the up and down positions and all three can move together as they are never lowered separately. The device is then immediately lifted to the operator position.

13. If more than one cycle is ordered then the boom rests at the operator position for the pause time entered in the table as the delay between cycles.

An Ice Cleaning Operation

The operator lowers the resurfacing device from the roof space 105 via a control panel located in a reception area. The boom assembly 1 lowers to the operator position, which is approximately 1 m above the surface of the ice. The operator then selects the cleaning resurfacing operation 165b and inputs the time available to cover the rink, the number of metres the boom assembly 1 should travel across the ice before pausing (A set distance of 60 m for a 60 m long rink will mean there are no pauses and the device will travel the full length of the rink at the constant speed set), the period for which the boom assembly 1 should pause, and the time for replacement water run. The PLC 15 then calculates the fixed flow rate for the supply of water. The operator then initiates the device.

1. See steps 1 to 9 of the resurfacing operation.

2. The boom assembly 1 moves over the ice at the set speed for the set distance of travel in the cleaning routine screen above and pauses for the set time. As the device moves over the ice, the surface of the ice is melted.

3. A cleaner with a wet vacuum follows behind the boom assembly 1 to remove the melt from the ice. The water is then either discarded or put into a holding tank for filtration and return to the rink on a replacement run. The recycling of water is helpful where water is scarce or where high quality water such as deionised or distilled water is used since this is expensive to purchase.

4. When the pause period ends, the boom moves over the surface of the ice for the set distance and pauses again for the set time. The process is repeated until the boom assembly 1 has moved across the entire rink, telescoping the retractable boom sections 7 in a similar manner to the resurfacing operation.

5. When completing a first run, and arriving at the barrier 100 opposite the start position, the retractable boom sections 7 are fully retracted and the boom assembly 1 aligns itself with the barrier 100 using the mechanical proximity sensors 87 on the front of the boom assembly. The heatable plates are lifted from the ice and remain energized.

6. On triggering the mechanical proximity sensors 87 against the far barrier 100, the boom assembly 1 reverses across the rink at very slow speed. The three inductive sensors 85 for detecting the foil strips 99 run just behind the boom so are only lowered onto the ice after the boom has moved away from the barrier 100. An off ice water hose is connected to the automatic water flow controller 171 to supply water to the boom assembly 1. No water is sprayed at this stage since the flow controller on the boom is shut.

7. A water flow switch on a manual control switchboard is pressed to actuate the water flow controller 171 and water flows through the boom to the water channels formed in the heatable plates 23. However, water does not issue from the plates since the plates are still raised and are impinging on the water supply lines.

8. The boom assembly 1 moves away from the barrier 100 and the heatable plates on the fixed boom sections 5 are lowered onto the ice. The boom assembly 1 moves across the rink at a speed governed by the value inputted by the operator into the HMI 165 corresponding to the time of water replacement run. As this occurs, water is able to flow through water channels 57,153,181 onto the ice.

9. As the boom assembly 1 moves away from the end barrier 100, the retractable boom sections 7 are deployed and the heatable plates mounted thereon are lowered onto the ice as they pass the end of the fixed boom sections. As the heatable plates are lowered onto the ice water sprays from the water channels.

10. The cycle is complete when the resurfacing device reaches the starting end, with the retractable boom sections 7 fully retracted and heatable plates 23,131,163 raised off the ice, thereby nipping off their water supply. The water hose is turned off and disconnected.

11. The operator then returns the boom to its park position, in the roof space 105.

### SECOND EMBODIMENT

A second embodiment of the invention is shown in FIGS. 35 to 38b. This embodiment comprises a boom assembly 1001 having a centre section 1003 and two fixed boom sections 1005 similar to those described for the first embodiment. The resurfacing device is arranged to be parked at rink level and does not have retractable boom sections and is particularly suited for when a new rink is designed to accommodate a resurfacing device of this type.

The boom assembly 1001 is arranged to move across the ice and to resurface the device by lowering heatable plates 1023 onto the surface. The power supply 1011 from to the boom assembly 1001 via busbars 1213 arranged substantially parallel to the ice rink and extending along the length of the rink (see FIG. 37). The busbars 1213 are arranged to provide a 415V three phase supply to the boom. The device includes a similar cell 1167 and charger 1169 arrangement to the first embodiment for supplying 24V to the sensors and the PLC 15 mounted on the boom. Since the device is parked at rink level and power is supplied from rink level, this obviates the need for the winching and cabling arrangement of the first embodiment. The boom assembly 1 is parked at one end of the rink and is moved back and forth across the ice via a motor driven rack and pinion (not shown) or screw 1013 drive system, which is located adjacent the busbars 1213 and is controlled by a PLC 1015 mounted in the centre section 1003 that is arranged to synchronise the operation of two drive system motors 1217 to maintain the alignment of the boom as it moves across the ice. Schematics of the power supplies and the rack and pinion systems are shown in FIGS. 37, 38a and 38b).

The boom is connected to each busbar 1213 and drive system 1215 by sliding bearings 1219. Each bearing 1219 has a tubular portion 1221 with an internal screw thread. The bearing 1219 is mounted on a threaded bar 1223 which extends along the length of the rink. As the bar 1223 rotates, the bearing 1219 moves along the bar and thus the boom is propelled along the surface of the ice. The sliding bearing also includes electrical contacts 1225 for engaging the busbars 1213.

The lower part of the barrier 1100 that surrounds the rink comprises a number of panels that are commonly known as kick boards 1227. The kick boards 1227 can be removed manually or can be arranged to move upwards automatically to allow the boom assembly 1 to move across the ice (see FIG. 34). Water hoses (not shown) can be attached to each end of the boom assembly 1001 for supplying water to water channels 1057 in the heater modules 1009. Each hose is mounted on a drum (not shown) that is rotated by a motor (not shown) arranged to synchronously payout/retract the hose in accordance with movement of the boom across the ice.

### THIRD EMBODIMENT

A third embodiment of the invention is shown in FIGS. 39 to 41. There is an increasing demand for machines to resurface small rinks, in particular temporary rinks that may be set up for a number of weeks over the winter. This is often in outdoor situations such as town squares, parks or the like, and also in indoor locations such as shopping malls. Most of these rinks are about 600 sq metres and are ideally resurfaced in about 10 minutes.

Therefore, there is a need is for a small manoeuvrable machine capable of considerable flexibility in terms of transport and storage. The embodiment of the invention shown in FIGS. 39 to 41 satisfies these requirements. This embodiment is based on similar operating principles to the embodiment described above, however the resurfacing device is not automatic but requires an operator.

The resurfacing device according to the second embodiment includes at least one heatable plate 2023, and preferably three heatable plates 2023, that are similar in structure and operation to those described above, a wheeled chassis 2229 for carrying the heatable plates 2023, a drive system 2013 for driving wheels 2071, three lifting mechanisms 2029 to adjust the vertical positions of the heatable plates 2023, control switches to operate the device, and a three phase electrical power supply 2011.

The heatable plates 2023 preferably have a length of lm but can be any practicable size. The heatable plates 2023 are arranged transversely to the forward direction of the chassis 229, in series. A series arrangement is preferred to enable the resurfacing device to travel faster over the ice. To increase the surface area of the ice that is melted in one pass, the heatable plates 2023 can be arranged in parallel, additional plates can be arranged in parallel or the length of the plates can be increased.

In the most basic version the operator grips handles 2235 attached to the chassis and controls the device via the control switches, which are conveniently located on the handles. The operator can be pulled behind the device on skates. Alternatively, a seat 2237 can be attached to the chassis so that the operator can ride the resurfacing device in a similar fashion to some lawn mowers.

The drive system 2013 includes two drive motors 2075 for driving left and right pairs of wheels 2071. The pairs of wheels are connected by a sprocket and chain arrangement. Steering is simply a matter of stopping or slowing the motor on one side or the other for brief periods. The speed of travel is variable and is preset by the operator.

Electrical power is supplied to the device via a cable 2239. The arrangement supplies 50 kW to the machine. The heatable plates 2023 are rated at 15 kW each making a total of 45 kW for a three plate machine. This will usually be available by diverting power from the refrigeration plant for the time the resurfacing is taking place. If, accidentally, the machine is directed towards the cable the arrangement of the plates simply pushes the cable out of the way.

A cleaning cycle can be performed by the device. This involves moving the device over the ice more slowly to increase the depth of melt. The melt is removed with a wet vacuum. Fresh water is then sprayed onto the rink manually to approximately replace the melt removed.

It will be appreciated by the skilled person that modifications can be made to the above embodiments that fall within the scope of the invention, for example a pump 241 and filter 243 arrangement can be included in the device for sucking up melt water from the ice and cleaning the water (see FIGS. 42a to 44). The water can then be directed to the water inlets in the heatable plates for redistribution over the surface of the rink. To facilitate the collection of water the heatable plates are arranged to channel the melt to a central point so that the pump/filter system can suck up the water from the surface of the ice (see FIG. 42)

The filters 243 and pumps 241 can be mounted on the structural/support members (see FIG. 42) or on the heatable plates (see FIG. 43). The plates are modified to enable the melt to be removed from the ice. Heating only occurs at the leading and trailing edges of the plates by hinged heatable shoes 245. The heatable shoes 245 are spring-loaded and are arranged to have a maximum range of movement of approximately 2 mm. The underside of the plate is recessed (see FIG. 44) and has two triangular sections 247 that are in contact with the ice and two triangular sections 249 that taper away from the ice when viewed in plan from the underside to a height of approximately 5 mm. The plate is arranged to make a seal with the ice so that water is pumped efficiently.

The melt water removed from the ice via a channel 251 in the plate and flows through the filter 243 and is then sprayed onto the surface via water channels located in the plate.

The retractable boom sections 7 can be mounted in front of the fixed boom sections 5, or arranged such that they extend from within the fixed boom sections (see FIG. 45).

In the embodiments described above, the heatable plates are arranged to be powered by electricity. As an alternative to electric heating, the heatable plates can be arranged to be heated by a hot liquid such as water (see FIGS. 46 and 47). For example, hot water can be distributed to the heatable plates via pipes 253 from the roof space in much the same manner as the electric cables distribute electricity to the boom. The pipes for distributing water to the plates are similar in size to the cables for distributing electricity. The main difference is that the water distribution involves returning the water to a cold water reservoir 255 whereas electrical distribution has the advantage of being a one way system.

The heat exchanger plate may comprise upper and lower aluminium sections that are bonded together with an epoxy resin. The plates are formed such that when the sections are superimposed a network of channels 257 is formed internally. The plate includes a water inlet 259 for receiving hot water from a hot reservoir and an outlet 261 for directing cooled water to a cold reservoir. Preferably, water is supplied to the plates at approximately 80 C. The heated plate radiates heat to melt the ice such and the exit temperature of the water is around 30 C.

The capital cost of this system is likely to be a little higher than the electrical system but the running costs may be considerably lower. This is because water in the hot reservoir can be heated using cheap over night electricity, solar power, wind power, gas boiler or any combination of those sources or any other suitable cheap source of energy. If only electricity is used to heat the water, and say 10 kW of power is available continuously, then a good resurface would be possible every 4 hours, which would be quite acceptable for most rinks.

Another advantage of using water heated plates is that it is only necessary to supply low voltage power (24V) to the boom assembly for propulsion and for controlling equipment, thereby reducing the risk of serious electrical mishap.

The water supplied boom works in an identical manner to an electricity supplied boom with water pipes replacing the electric cable in a closed system, and can perform the same operations as the electric boom. Water starts its journey from an off-ice hot water tank 263 at 80 C, is routed through the boom plates and returns to a cool tank at 30 C. To achieve the necessary heat transfer for the normal requirements of resurfacing, a flow rate of 8 Kg/second is required.

A schematic of a typical system is shown in FIG. 46. The hot water is driven by a pump 265 from the hot water tank 263 approximately 100 m through pipes 253 having diameters in the range 50 to 75 mm internal diameter to a manifold 267 10 m above the reservoirs and heat exchanger. The water is then directed into eight pipes 269 having diameters of less than 22 mm, passes through the plates and is returned to a cold water tank via the manifold 267, approximately 100 m away from the manifold. Preferably, the pump 265 is rated at 7 HP.

The water channels formed in the heatable plates and the water supply system can be omitted for more simple embodiments.

1. A device for resurfacing an ice rink or track comprising a drive system for moving the device over the surface of the ice rink or track, and one or more heater devices comprising a heat source and a conductive member for transferring heat from the heat source to the surface of the ice.

2. A device according to claim 1, further comprising a computer controller.

3. A device according to claim 2, wherein the computer controller is arranged to control the depth to which the ice is melted.

4. A device according to claim 3, wherein the computer controller is arranged to control the amount of heat supplied to the or each heater device.

5. A device according to claim 4, wherein the computer controller is arranged to periodically interrupt the supply of heat to the one or more heater devices.

6. A device according to claim 2, wherein the computer controller is arranged to control operation of the drive system.

7. A device according to claim 1, wherein the conductive member has a substantially planar surface for contacting the ice.

8. A device according to claim 1, wherein the conductive member includes means for reducing warping caused by differential heating of the body.

9. A device according to claim 1, wherein the one or more heater devices further comprise at least one thermostatic device for monitoring the temperature of the conductive member.

10. A device according to claim 1, including a plurality of heater devices.

11. A device according to claim 1, wherein the vertical position of the or each heater device relative to the surface of the ice is adjustable.

12. A device according to claim 1, wherein the heat source is arranged to heat the conductive member, in use, to a temperature within the range 20 to 100 degrees Celsius.

13. A device according to claim 1, wherein the heat source comprises at least one electrically eatable element.

14. A device according to claim 1, wherein the at least one heat source comprises a liquid.

15. A device according to claim 1, wherein the one or more heater devices are mounted on an elongate structure and the drive system is arranged to move the elongate structure across the surface of the ice.

16. A device according to claim 15, wherein the elongate structure comprises a fixed section 5 and one or more moveable sections for adjusting the effective length of the elongate structure.

17. A device according to claim 16, comprising at least one sensor for detecting the position of the one or more moveable sections.

18. A device according to claim 16, further comprising means for determining the alignment of the or each moveable section relative to the fixed section 5.

19. A device according to claim 1, comprising a plurality of heater devices arranged to extend substantially across the width or length of the rink or track thereby forming a substantially continuous melting zone across the rink or track.

20. A device according to claim 1, comprising means for adjusting the alignment of the resurfacing device as it moves across the ice.

21. A device according to claim 20, wherein the means for adjusting the alignment of the resurfacing device comprises a plurality of sensors for detecting an arrangement of markers located below the ice.

22. A device according to claim 21, wherein the sensors for detecting the markers are arranged to measure the depth of ice.

23. A device according to claim 20, wherein the means for adjusting the alignment of the resurfacing device includes an arrangement of lasers, sensors and reflectors for determining whether the device is correctly aligned.

24. A device according to claim 1, wherein the drive system includes a plurality of wheel modules having a plurality of wheels, a motor arranged to drive the wheels and an encoder for supplying operational information to the computer controller.

25. A device according to claim 24, wherein the wheels are arranged to grip the ice when rotated about their axes of rotation and are arranged to slide over the ice when driven in a direction substantially parallel to their axes of rotation.

26. A device according to claim 25, wherein the wheels comprise a plurality of grooves and teeth formed alternately in the curved surface of the wheel.

27. A device according to claim 26, wherein each tooth has a channel formed in its upper surface, thereby forming two ridges extending along the length of the tooth.

28. A device according to claim 1, comprising at least one cell for supplying electrical power to at least one of the drive system, the computer controller, the lifting means and the sensors, and a cell charger connected to a mains supply for providing power to the cell.

29. A device according to claim 1, comprising a winch system for adjusting the vertical position of the resurfacing device relative to the rink or track.

30. A device according to claim 29, comprising at least one flexible electrical connector attached to a mains supply for supplying electricity to the one or more heater devices and the cell charger, wherein the winch system is arranged to payout and retract the or each flexible electrical connector when the resurfacing device is lowered and raised respectively.

31. A device according to claim 1, wherein the drive system comprises at least one of a rack and pinion drive assembly and a screw drive assembly.

32. A device according to claim 1, arranged to receive electrical power from electrical supply lines extending substantially along the length or width of the rink or track.

33. A device according to claim 1 comprising water supply means for distributing water over the surface of the ice.

34. A device according to claim 33, wherein the one or more devices comprise a network of channels and water outlets for depositing water onto the surface of the ice.

35. A device according to claim 34, wherein the means for adjusting the vertical position of the heater device is arranged to move the heater device to a position in which it impinges on a water supply line and thereby inhibits the supply of water to the heater device.

36. A device according to claim 1, comprising means for removing melt water from the surface of the ice.

37. A device according to claim 36, including filter means for cleaning water removed from the ice.

38. A heater device for an ice rink resurfacing device including a heat source and a conductive member for transferring heat from the heat source to the surface of the ice.

39. A heater device according to claim 38, wherein the heat source includes an electric heating element comprising a nichrome ribbon coated in an electric insulating material.

40. A heater device according to claim 38, wherein the heat source comprises a liquid.

41. A heater device according to claim 38, wherein the heat source is arranged to heat the conductive member, in use, to a temperature within the range 20 to 100 degrees Celsius.

42. A heater device according to claim 38, including means for reducing warping caused by differential heating of the body.

43. A heater device according to claim 1, including water supply channels and outlets arranged for dispersing water on to the surface of the ice.

44. A wheel for an ice resurfacing device drive system arranged rotation about an axis and to grip the ice when driven about its axis and to slide over the ice when driven in a direction substantially parallel to the axis of rotation.

45. A wheel according to claim 44, including a plurality of grooves and teeth formed alternately in the curved surface of the wheel.

46. A wheel according to claim 45, wherein each tooth is profiled to include at least one ridge in its outer surface.

47. A winch system for raising and lowering an ice resurfacing device comprising at least one flexible connector for supporting the weight of the resurfacing device, first and second fixed pulley wheels, a moveable pulley wheel, and a drive system for moving the moveable pulley wheel, wherein the flexible connector is anchored at one end to a support and is wrapped around the pulley wheels, and the position of the ice resurfacing device is controlled by the drive system adjusting the position of the moveable pulley wheel.

48. A winch system according to claim 47, comprising a plurality of flexible connector elements for supporting the weight of the resurfacing device.

49. A winch system according to claim 47 comprising at least one electrical supply cable for supplying electrical power to the ice resurfacing device from a power source.

50. A winch system according to any one of claim 47 further comprising at least one control cable for carrying electrical signals from a computer controller located on the ice resurfacing device to the drive system.

51. A winch system according to claim 47, further comprising at least one sensor for determining the position of the ice resurfacing device.
